(19) United States
(12) Patent Application Publication
(10) Pub. No.: US 2010/0289874 A1
(43) Pub. Date: Nov. 18, 2010

(54) SQUARE TUBE MIRROR-BASED IMAGING SYSTEM

(76) Inventor: FUHUA CHENG, Lexington, KY (US)

Correspondence Address: KING & SCHICKLI, PLLC, 247 NORTH BROADWAY, LEXINGTON, KY, 40507, US

(21) Appl. No.: 12/781,476

(22) Filed: May 17, 2010

Related U.S. Application Data
(60) Provisional application No. 61/178,776, filed on May 15, 2009.

(51) Int. Cl. H04N 13/00; G02B 27/14; H04N 13/02

(52) U.S. Cl. 348/43; 359/629; 348/49; 348/E13.074; 348/E13.001

(57) ABSTRACT

A system is described for providing a three-dimensional representation of a scene from a single image. The system includes a reflector having a plurality of reflective surfaces for providing an interior reflective area defining a substantially quadrilateral cross section, wherein the reflector reflective surfaces are configured to provide nine views of an image. An imager is included for converting the nine-view image into digital data. Computer systems and computer program products for converting the data into three-dimensional representations of the scene are described.

This application claims the benefit of U.S. Provisional Patent Application Ser. No. 61/178,776, filed May 15, 2009, the entirety of the disclosure of which is incorporated herein by reference.

### TECHNICAL FIELD

The present invention relates to the art of three dimensional imaging. More particularly, the invention relates to devices and methods for three-dimensional imaging, capable of generating stereoscopic images and image-plus-depth utilizing a single imager and image.

### COPYRIGHT

A portion of the disclosure of this document contains materials subject to a claim of copyright protection. The copyright owner has no objection to the reproduction by anyone of the patent document or the patent disclosure as it appears in the U.S. Patent and Trademark Office patent files or records, but reserves all other rights with respect to the work.

### BACKGROUND OF THE INVENTION

Conventional stereo imaging systems require multiple imagers such as cameras, to obtain images of the same scene from different angles. The cameras are separated by a distance, similar to human eyes. A device such as a computer then calculates depths of objects in the scene by comparing images shot by the multiple cameras. This is typically done by shifting one image on top of the other one to identify matching points. The shifted amount is called the disparity. The disparity at which objects in the images best match is used by the computer to calculate their depths.

Prior art multi-view imaging systems use only one camera to calculate the object depth. In most cases, such a system uses specially designed mirrored surfaces to create virtual cameras. With the views captured by the real camera and the virtual cameras the computer can use the same scheme as in classic computer vision to calculate the depth of an object.

One prior art multi-view imaging system (Yuuki Uranishi, Mika Naganawa, Yoshihiro Yasumuro, Masataka Imura, Yoshitsugu Manabe, Kunihiro Chihara: Three-Dimensional Measurement System Using a Cylindrical Mirror, SCIA 2005: 399-408) uses a cylindrical mirror (CM) to create virtual cameras. The CM is a hollow tube or chamber providing mirrored surfaces on the interior. The camera, equipped with a fish eye lens, captures the scene through the mirror. A CM can create infinitely many symmetric virtual cameras, one for each radial line, if the real camera lies on the center line of the CM, for each point in the captured image (image inside the center circle), correspondence can be found on some radial lines of the image. Another prior art system (U.S. Pat. No. 7,420,750) provides a cylindrical mirror device wherein a front end and rear end of the CM can have different dimensions.

The advantage of such a cylindrical mirror device is that the user can always find corresponding points on the same diameter line of the image. This is because each radial slice of the captured image has its own virtual camera. However, this property requires that the optical axis pass through a center axis of the mirror and further that the optical axis be parallel to every mirror surface tangent plane. Such devices are difficult to calibrate, and generate heavily blurred images. A point on the object corresponds to a very large area in the reflection if that point is close to the center of the mirror. This is because the distance between the object and the virtual camera is much longer than the distance between the object and the real camera, but the focusing distances of the real and virtual cameras are still the same. The blurring of the images makes the work of identifying the corresponding point for a point on the object very difficult.

Accordingly, a need is identified for an improved devices and method for multi-view imaging systems. The multi-view imaging systems set forth in the present disclosure provides a plurality of corresponding images from a single camera image, without the blurring of images noted in prior art systems. Still further, the present disclosure provides methods for deriving stereoscopic images and image-plus-depth utilizing a single imager and image. The described imaging system finds use in a variety of devices and applications, including without limitation (1) providing three-dimensional contents to three-dimensional photo frames, three-dimensional personal computer displays and three-dimensional television displays; (2) specialized lenses for document cameras and endoscopes so these devices can generate stereoscopic images and image-plus-depth; (3) three-dimensional Web cameras for personal computers and three-dimensional cameras for three-dimensional photo frames and mobile devices (such as intelligent cell-phones); (4) three-dimensional representations of the mouth and eyes of a patient.

### SUMMARY OF THE INVENTION

To solve the aforementioned and other problems, there are provided herein novel multi-view imaging systems. In accordance with a first aspect of the invention, a system is described for providing a three-dimensional representation of a scene from a single image. The system includes a reflector for providing an interior reflective area defining a substantially quadrilateral cross section, wherein the reflector reflective surfaces are configured to provide nine views of an image. In particular embodiments, the reflector may define a square or rectangle in side view, or may define an isosceles trapezoid in side view. An imager may be provided to convert the nine-view image from the reflector into digital data. The data may be rendered into stereoscopic images or image-plus-depth renderings.

In another aspect there is provided a software for rendering a nine view image provided by the system described above into a stereoscopic image or an image-plus-depth rendering, including a first component for identifying a camera location relative to a scene of which a nine view image is to be taken, a second component for identifying a selected point in a central view of the nine view image and for identifying points corresponding to the selected point in the remaining eight views, and a third component for identifying a depth of the selected point or points in the central view. A fourth software component combines the corresponding points data and the depth data to provide a three-dimensional image. The second and third components may be the same, and/or may identify depth and corresponding points concurrently.

In yet another aspect, there is provided a computing system for rendering a nine view image into a stereoscopic image or an image-plus-depth rendering. The computing system includes a camera for translating an image into a digital form, and a reflector as described above. There is also provided a computing device or processor for receiving data from the camera and converting those data as described above to provide a three-dimensional image from a single image obtained by the camera.

These and other embodiments, aspects, advantages, and features will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims. Unless otherwise indicated, any patent and non-patent references discussed herein are incorporated in their entirety into the present disclosure specifically by reference.

### BRIEF DESCRIPTION OF THE DRAWING

The accompanying drawings, incorporated herein and forming a part of the specification, illustrate several aspects of the present invention and together with the description serve to explain certain principles of the invention. In the drawings:

FIG. 1 shows a square-tube mirror based imaging system according to the present disclosure;

FIG. 2 shows the square-tube mirror (STM) of FIG. 1;

FIG. 3 graphically depicts a nine-view STM image;

FIG. 4 shows a focused STM image;

FIG. 5 shows a defocused STM image;

FIG. 6 graphically depicts the corners of the central, left, and right views of FIG. 3;

FIG. 7 shows the image of FIG. 6 after rotation, clipping, and translation;

FIG. 8 depicts a point (P) in a virtual central view of an STM image, and the corresponding point (P′) in the virtual right view;

FIG. 9 schematically shows a top view of an STM with d>l;

FIG. 10 schematically shows an STM wherein the field of view of a camera covers the STM and additional space;

FIG. 11 schematically depicts an STM with d>½ but d<l;

FIG. 12 schematically depicts a sloped STM;

FIG. 13 depicts a labeled nine-view STM image;

FIG. 14 shows an STM image angle α;

FIG. 15 schematically depicts an STM wherein the field of view of the camera covers only a portion of the STM;

FIG. 16 schematically depicts an STM wherein the field of view of the camera covers more than the entire STM;

FIG. 17 schematically depicts a corresponding point P in a virtual right view of an STM;

FIG. 18 schematically depicts a situation wherein a corresponding point of P does not exist in the virtual right view of an STM image;

FIG. 19 schematically depicts a projection of a point onto a virtual image plane with respect to an actual camera;

FIG. 20 schematically depicts a point in a virtual right view of an STM image, and that points counterpart in the STM image right view;

FIG. 21 schematically depicts a point in a virtual left view of an STM image, and that points counterpart in the STM image left view;

FIG. 22 schematically depicts a patient mouth reproducing device;

FIG. 23 schematically depicts an STM-based intraoral imaging device;

FIG. 24 schematically depicts an STM-based Web camera for three-dimensional imaging; and

FIG. 25 shows a nine-view image provided by the STM-based Web camera of FIG. 24.

### DETAILED DESCRIPTION OF THE INVENTION

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention. Also, it is to be understood that other embodiments may be utilized and that process, materials, reagent, and/or other changes may be made without departing from the scope of the present invention.

### Square-Tube Mirror-Based Imaging Device

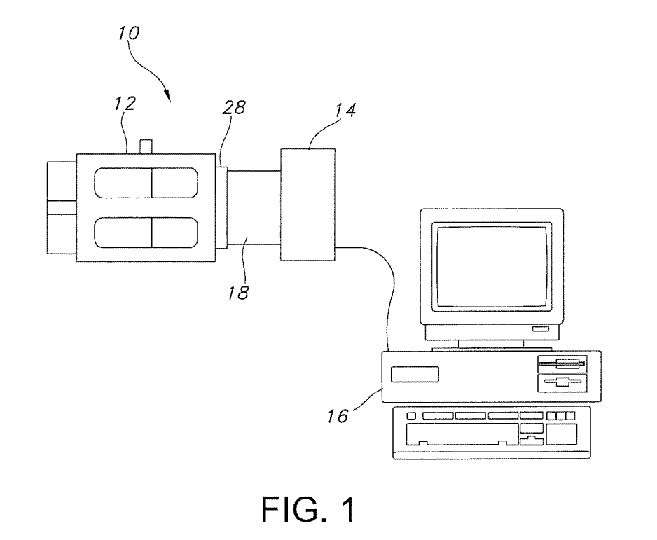

In one aspect, the present disclosure provides a Square Tube Mirror-based Imaging System 10 (hereinafter STMIS; schematically depicted in FIG. 1) comprising a square tube mirror (STM) 12, an imager 14 such as a digital camera, a computer 16 and a set of stereoscopic image generation, depth computation, modeling and rendering programs.

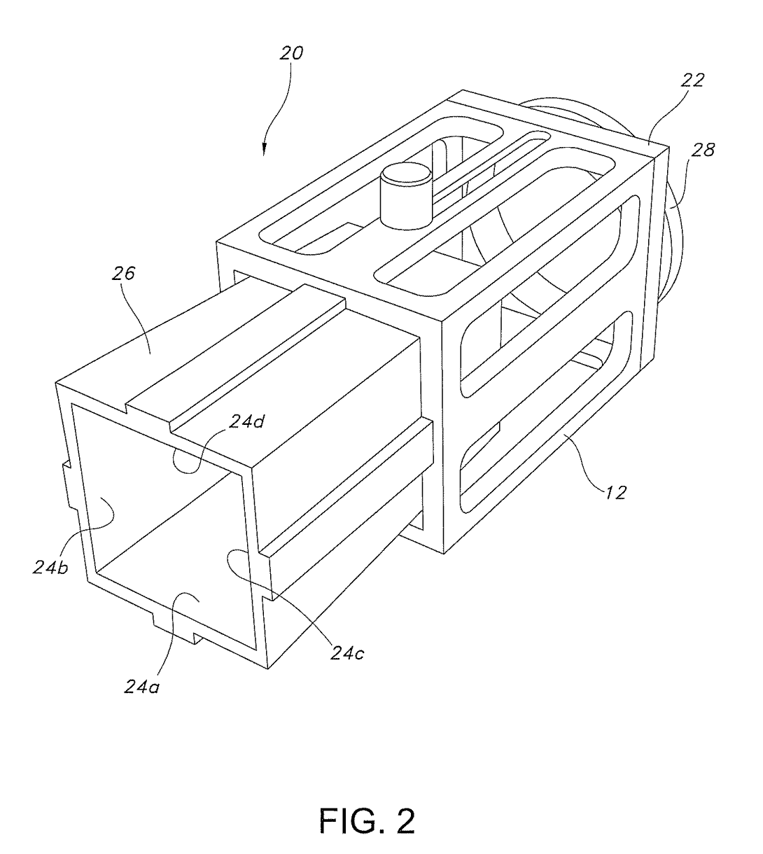

In one embodiment (see FIG. 2), the STM 12 comprises an interior component 20 and an outer frame 22. The interior component comprises four substantially identically-shaped planar reflective surfaces 24a, b, c, d supported by a housing 26, defining in cross-section a substantially square shape. The reflective surfaces will be selected from materials which do not create double reflections. The STM 12 may define in side view a quadrilateral such as a square, a rectangle, a pyramid, an isosceles trapezoid, or the like. The outer frame 22 is provided to support the housing 26, and to cooperatively connect the interior component with the lens 18 of an imager 14 such as a digital camera. Typically, the outer frame 22 will also comprise a mechanism to adjust a distance between the interior, reflective surfaces 24a, b, c, d and a pinhole (not shown) of the imager 14. That is, the housing 26 is adapted to be slidably displaceable within the outer frame 22, to allow incremental adjustment of a distance between an end of the interior component 20 and the imager 14 pinhole. The STM is connected to the lens 18 of the imager 16 by substantially conventional means, such as by providing cooperating threaded fasteners 28, 30 at a rear portion of the STM 12 and at a front portion of the imager 14 or lens 18.

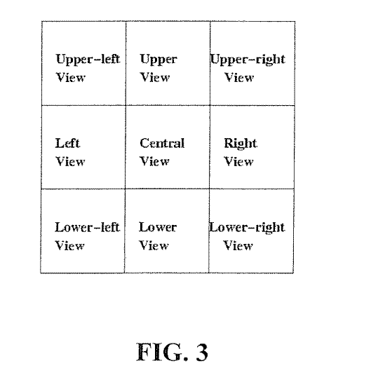

A major feature of the described STM 12 is that, when a user views a scene, nine discrete views of the scene are provided, as if the user is viewing at the scene from nine different view points and orientations concurrently. This is because in addition to the center view, the user also is provided eight reflections of the scene from the four reflective surfaces 24a, b, c, d. Four of the views are generated by reflecting the scene once and four of the views are generated by reflecting the scene twice. Therefore, each picture taken by the camera in the present STM-based imaging system is composed of nine different views of the scene. Such a picture is called an STM image. The nine different views, arranged in a 3×3 rectangular grid, are composed of a central view, a left view, a right view, a lower view and a upper view (reflected once) and four corner views (reflected twice). FIG. 3 provides a representation of the described grid.

As will be described in greater detail below, information from these different views can be used by the software of the system to generate stereoscopic images or image-plus-depths of the objects in the scene. Thus, a user can generate 3D images with only one camera and one picture. Broadly, an image-plus-depth is generated by combining the central view of an STM image with a depth map computed for the central view of that STM image. Once a region in the central view of an STM image is specified, a stereoscopic image is generated by taking appropriate regions from the left view and the right view of that STM image and interlacing these regions.

The reflective interior component of the STM may be made of any suitably reflective surface, with the proviso that double image reflections are to be avoided. Without intending any limitation, in particular embodiments, the reflective surfaces may be fabricated of stainless steel, aluminum, or any suitable reflective material which does not create double images. Typically, use of glass is avoided due to the generation of double reflections thereby. The housing 26 for the reflective surfaces 24a, b, c, d may be made of any suitable material, such as metal, plastics, other polymers, and the like. In one embodiment, the housing 26 is molded as a unitary housing 26, of polymethylmethacrylate (PMMA) or any other suitable plastic or polymer.

### Stereoscopic Images

Herein is described a technique to generate stereoscopic images using an STMIS as described. Broadly, the method comprises, for a specified region in a central view of an STM image (see FIG. 3), there is identified the corresponding regions in the left view and the right view of the image (as a non-limiting example, the ‘Right image’ and the ‘Left image’ shown in FIG. 3). Next, the images are interlaced, and the interlaced image can then be viewed with a pair of special glasses (shutter glasses or polarized glasses) on a 3D display panel designed for stereoscopic images. Such specialized glasses and 3D display panels are known in the art.

For this particular application the left view and the right view first require rectification. The accuracy of the rectification process relies on accurate identification of the central view, the left view and the right view. In the following we show how to accurately identify the bounding edges of these views and then how to perform the rectification process.

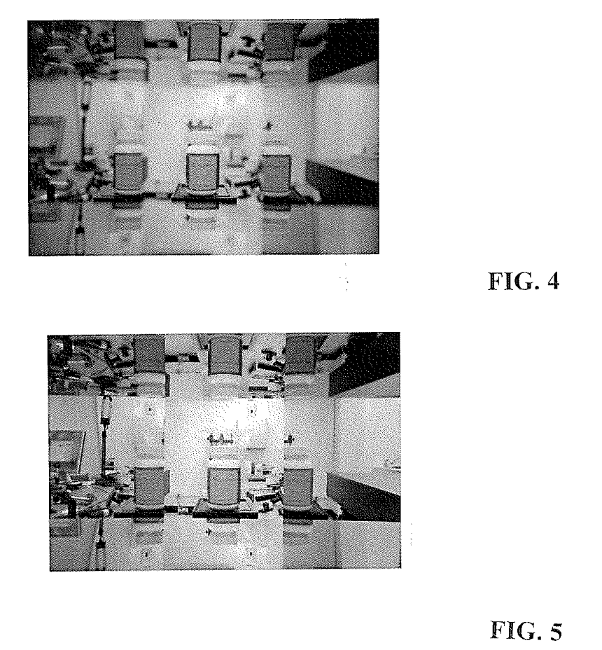

First, the bounding edges of the central view are identified via a focus/defocus process. A first image of a scene is acquired (see FIG. 4). Typically, bounding edges of the central view appear blurry if the scene is not close to the front end of the STM. This is because the focus is on the scene of which an image is being taken, not on the front end of the STM. To accurately identify the bounding edges of the central view, it is necessary to acquire a second image of the scene, but with the smallest camera iris this time. This second image will be exactly the same as the first image except now the scene is not as clear but the bounding edges of the central view in the second image are very clear and sharp (see FIG. 5). By clearly identifying the bounding edges of the central view in the second image, it is possible to compute the four corners of the central view in the second image.

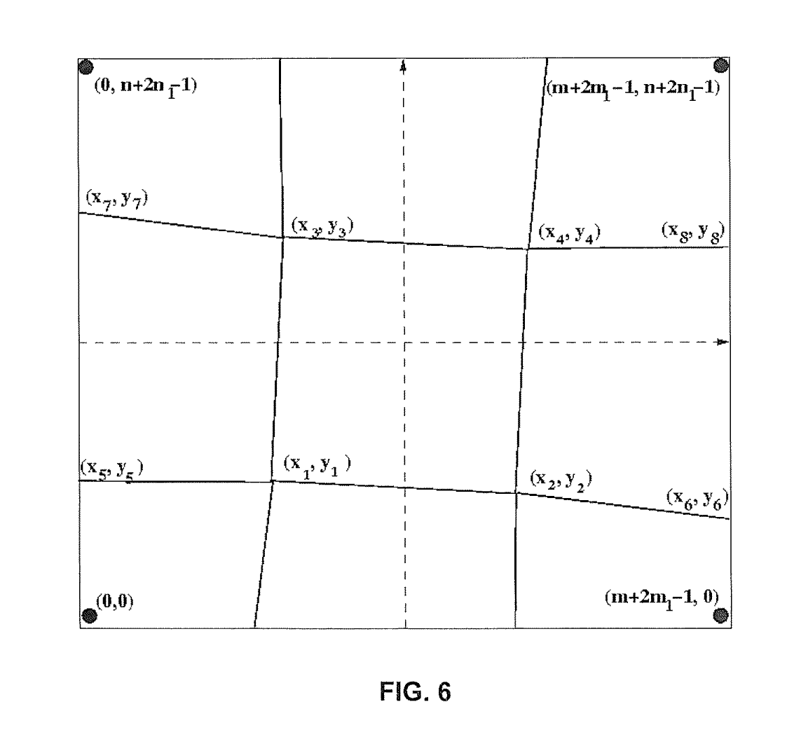

These four corners of the second view in the second image correspond to the four corners of the central view in the first image. The coordinates of these corners are defined as (x₁,y₁), (x₂,y₂), (x₃,y₃), and (x₄,y₄) (see FIG. 6) with respect to the lower-left corner of the image, i.e., the lower-left corner is the origin of the coordinate system of the image.

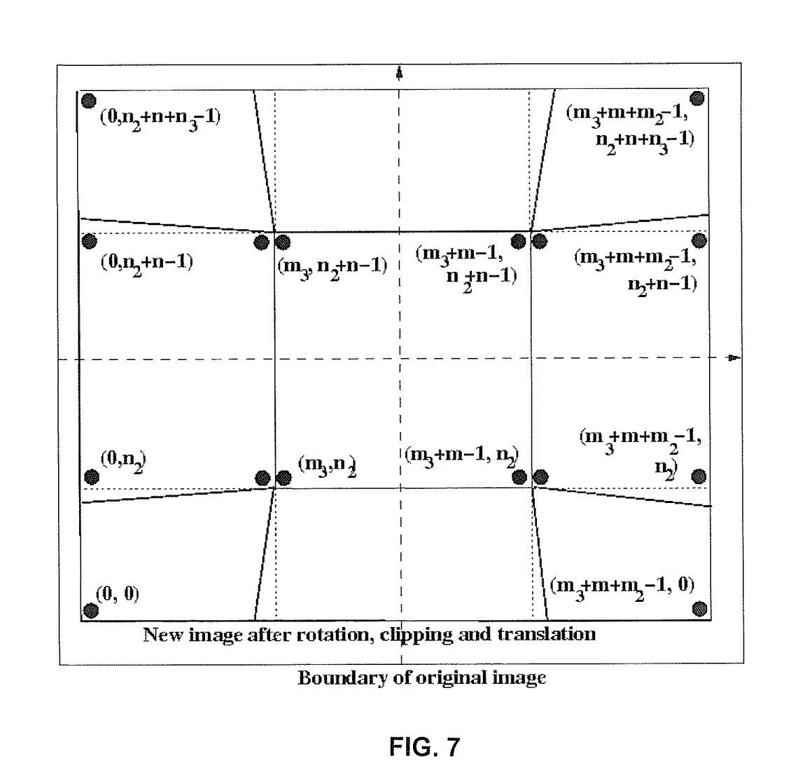

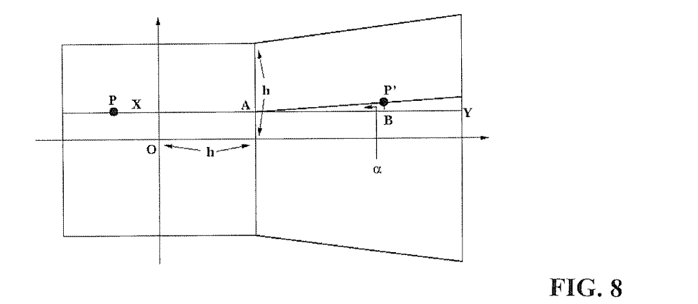

Next job is identification of (x₅,y₅), (x₆,y₆), (x₇,y₇) and (x₈,y₈) (see FIG. 6). Without loss of generality, it is presumed that (x₁,y₁) and (x₂,y₂) lie on the same horizontal line. If this is not the case, the image must simply be rotated about the center of the central view for β degrees where β=tan⁻¹((y₂−y₁)/(x₂−x₁)) and do a clipping after the rotation to ensure the image is an orthogonal rectangle (see FIG. 7). A translation is also necessary if center of the new central view does not coincide with the center of the original image.

The following theorem is used for the rectification process:

THEOREM 1 If P=(X,Y,−l) is a point in the virtual central view corresponding to a given STM image and P′ is the corresponding point of P in the virtual right view, then the edge AP′ makes an angle of α degrees with the horizontal line y=Y and α is a function of Y

$$α = {tan}^{- 1} ( \frac{Y sin ( 2 θ )}{( d + l ) cos ( 2 θ ) + h sin ( 2 θ )} ) \qquad ( 1 )$$

PROOF Since tan α=|P′B|/|AB|, we need to find |P′B| and |AB| in order to compute α. By Theorem 1, we have

$${P}^{′} = ( \frac{( d + l ) ( X + 2 {σ}_{r} cos θ )}{d + l - 2 {σ}_{r} sin θ} , \frac{( d + l ) Y}{d + l - 2 {σ}_{r} sin θ} , - l )$$

Hence,

$$\begin{matrix}\vert {P}^{′} B \vert = \frac{( d + l ) Y}{d + l - 2 {σ}_{r} sin θ} - Y \\ = \frac{( d + l ) Y - ( d + l ) Y + 2 Y {σ}_{r} sin θ}{d + l - 2 {σ}_{r} sin θ} \\ = \frac{2 Y ( h - X ) cos θ sin θ}{d + l - 2 ( h - X ) cos θ sin θ}\end{matrix}$$

On the other hand,

$$\begin{matrix}\vert AB \vert = \frac{( d + l ) ( X + 2 {σ}_{r} cos θ )}{d + l - 2 {σ}_{r} sin θ} - h \\ = \frac{( d + l ) ( X + 2 {σ}_{r} cos θ ) - h ( d + l ) + 2 h {σ}_{r} sin θ}{d + l - 2 {σ}_{r} sin θ} \\ = \frac{( d + l ) ( X - h ) + 2 {σ}_{r} ( ( d + l ) cos θ + h sin θ )}{d + l - 2 {σ}_{r} sin θ} \\ = \frac{( d + l ) ( X - h ) + 2 ( h - X ) cos θ ( ( d + l ) cos θ + h sin θ )}{d + l - 2 {σ}_{r} sin θ} \\ = \frac{( d + l ) ( X - h ) + 2 ( d + l ) ( h - X ) {cos}^{2} θ + 2 ( h - X ) h cos θ sin θ}{d + l - 2 {σ}_{r} sin θ} \\ = \frac{( d + l ) ( h - X ) ( 2 {cos}^{2} θ - 1 ) + 2 ( h - X ) h cos θ sin θ}{d + l - 2 {σ}_{r} sin θ} \\ = \frac{( d + l ) ( h - X ) cos ( 2 θ ) + ( h - X ) h sin ( 2 θ )}{d + l - 2 {σ}_{r} sin θ}\end{matrix}$$

Therefore,

$$\begin{matrix}tan α = \frac{2 Y ( h - X ) cos θ sin θ}{( d + l ) ( h - X ) cos ( 2 θ ) + ( h - X ) h sin ( 2 θ )} \\ = \frac{Y sin ( 2 θ )}{( d + l ) cos ( 2 θ ) + h sin ( 2 θ )}\end{matrix}$$

And the theorem is proved. Ξ

It is assumed that, after the steps of rotation, clipping and translation, the widths of the left view, the central view and the right view are m₃, m and m₂, respectively, and the heights of the lower view, the central view and the upper view are n₂, n and n₃, respectively (see FIG. 6). Hence, for the right view, the rectification process is to restore it into an image of dimension m₂×n. For the left view, the rectification is to restore it into an image of dimension m₃×n. We will show the rectification for the right view only. The rectification process for the left view is similar.

Let I_{R} be an image array of dimension m₂×n. The rectified right view is stored into I_{R}. Another assumption is that the given STM image (after the rotation, clipping and translation steps) is stored in the image array I of dimension (m₃+m+m₂)×(n₂+n+n₃). Hence, the question to be answered is:
for J=0 to n−1
for i=0 to m₂−1
I_{R}(i,j)=?

One method for calculation is as follows:

First, for the given entry (i,j), its corresponding entry (M,N,−l) is found in the virtual right view of the virtual image plane. M and N are defined as follows:

$$\{ \begin{matrix}M = ( i + \frac{1}{2} ) \frac{2 h}{m} + h \\ N = ( j + \frac{1}{2} ) \frac{2 h}{n} - h\end{matrix} \qquad ( 2 )$$

Next is the step of finding the entry (X,N,−l) in the virtual central view such that

$$\frac{( d + l ) [ X + 2 ( h - X ) {cos}^{2} θ ]}{d + l - 2 ( h - X ) cos θ sin θ} = M \qquad ( 3 )$$

Such an X is defined as follows:

$$X = \frac{( d + l ) h cos ( 2 θ ) + ( d + l ) ( h - X ) + Mh sin ( 2 θ )}{M sin ( 2 θ ) + ( d + l ) cos ( 2 θ )} \qquad ( 4 )$$

Then based on Theorem 1, the corresponding point of (X,N,−l) in the virtual right view is computed as follows:

$$( M , \overline{N} , - l ) = ( M , \frac{( d + l ) N}{d + l - 2 ( h - X ) cos θ sin θ} , - 1 ) \qquad ( 5 )$$

Next, the corresponding location of (M, N̅,−l) in the right view of the STM image I is computed as follows:

(m₃+m+i,n₂+ j̅) (6)

where

$$\overline{j} = ( \overline{N} + h ) \frac{n}{2 h} - \frac{1}{2} \qquad ( 7 )$$

By combining (7) with (5) and (4), we get the following expression for j̅:

$$\overline{j} = [ \frac{N [ M sin ( 2 θ ) + ( d + l ) cos ( 2 θ ) ]}{( d + l ) cos ( 2 θ ) + h sin ( 2 θ )} + h ] \frac{n}{2 h} - \frac{1}{2} \qquad ( 8 )$$

where M and N are defined in (5-2). j̅ is typically a real number, not an integer.

Once we have the indices defined in (6) and the value of j̅ defined in (8), we can compute I_{R}(i,j) as follows:

(a) if j=(n−1)/2 then I_{R}(i,j)=I(m₃+m+i,n₂+j)

(b) if j>(n−1)/2 and l≦ j̅<l+1 for some l≧j then

I_{R}(i,j)=( j̅−l)I(m₃+m+i,n₂+l+1)+(l+1− j̅)I(m₃+m+i,n₂+l)

(c) if j<(n−1)/2 and k−1< j̅≦k for some k≦j then

I_{R}(i,j)=( j̅+1−k)I(m+m+i,n₂+k)+(k− j̅)I(m₃+m+i,n₂+k−1)

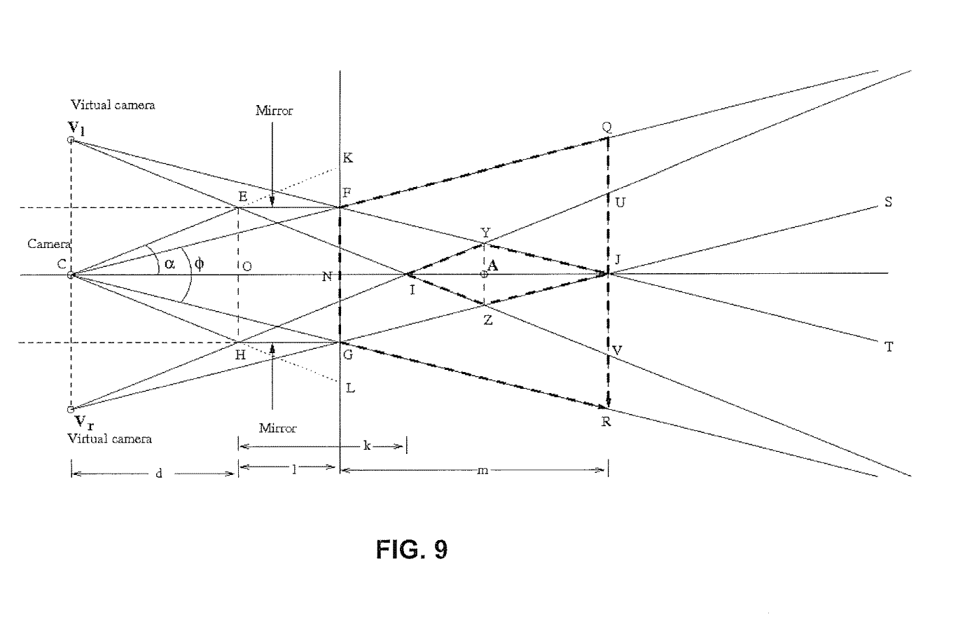

An alternative method for computing j̅ may be done via a shorter process. It can be seen that the right view of the STM image is similar to the virtual right view of the virtual image. Therefore, if Q=(i,j) and Q′=(i, j̅) in the right view of the STM image correspond to B=(M,N,−l) and P′=(M, N̅,−l) in the virtual right view, respectively, then the angle ∠P′ AB in FIG. 8 and the angle ∠Q′DQ in FIG. 9 must be the same. Consequently, by THEOREM 1, it is possible to compute the point Q′=(i, j̅) in the right view of the STM image by solving the following equation:

$$\frac{\vert {Q}^{′} Q \vert}{\vert DQ \vert} = tan α \qquad ( 9 )$$

for Q′ where D=(−½,j). Note that in the right view of the STM image, it is D, not (0,j) (see FIG. 9), that corresponds to A in the virtual right view (see FIG. 8). Since the aspect ratio of the STM image is:

$$Aspect ratio = \frac{x}{y} = \frac{2 h / m}{2 h / n} = \frac{n}{m}$$

(9) can be written as

$$\frac{\overline{j} - j}{[ i - ( - \frac{1}{2} ) ] \frac{n}{m}} = tan α = \frac{N sin ( 2 θ )}{( d + l ) cos ( 2 θ ) + h sin ( 2 θ )} \qquad ( 10 )$$

From (2), we have

$$i = ( M - h ) \frac{m}{2 h} - \frac{1}{2} ; j = ( N + h ) \frac{n}{2 h} - \frac{1}{2}$$

Hence, from (10) we have

$$\begin{matrix}\overline{j} = ( N + h ) \frac{n}{2 h} - \frac{1}{2} + \frac{N sin ( 2 θ )}{( d + l ) cos ( 2 θ ) + h sin ( 2 θ )} ( M - h ) \frac{m}{2 h} \frac{n}{m} \\ = ( N + h + \frac{N sin ( 2 θ ) ( M - h )}{( d + l ) cos ( 2 θ ) + h sin ( 2 θ )} ) \frac{n}{2 h} - \frac{1}{2} \\ = ( \frac{N [ M sin ( 2 θ ) + ( d + l ) cos ( 2 θ ) ]}{( d + l ) cos ( 2 θ ) + h sin ( 2 θ )} + h ) \frac{n}{2 h} - \frac{1}{2}\end{matrix} \qquad ( 11 )$$

(11) is exactly the same as (8).

The computation process of I_{R}(i,j) is the same as the one shown previously.

Once the left view and the right view of the STM image are rectified as described herein, the generation of stereoscopic images is relatively straightforward. For any specified region in the central view, the corresponding regions in the rectified left view and the rectified right view are identified, divided by 78% and interlaced. Next, the interlaced image is output to a display panel designed for stereoscopic images. Such panels are known in the art.

Consideration was given to the physical proportions of the STM, and to the relationship between the STM and the imager. Table 1 defines notations used subsequently.

TABLE 1

| Nomenclature | |
|---|---|
| Notation | Meaning |
| 1 | Length of the STM |
| 2r × 2r | Dimension of the rear end (adjacent to the camera lens) |
| 2h × 2h | Dimension of the front end |
| 1 × 2r × 2h | Dimension of each mirror (each mirror is of the shape of |
| | an [symbol] es trapezoid with 1, 2r and 2h being its height, top |
| | side length [symbol] ttom side length, respectively) |
| d | Distance between pinhole of the camera and center point |
| | of [symbol] rear end |
| θ | Slope of the interior of the hollow tube (angle between |
| | the and the optical center of the tube) |
| 2α | Field of view (or, angle of view) of the camera |
| φ | Effective field of view of the camera |

[symbol]

indicates data missing or illegible when filed

a. Parallel STM

First was the case that the interior slope of the STM is zero, i.e., θ=0. In this case, we have r=h and the mirrors form two pairs of parallel sets: (top mirror, bottom mirror) and (left mirror, right mirror). Each mirror is a rectangle of dimension 2r×l. We refer to this case as parallel STM.

Considering the situation of an STM with d>l, where EF, HG, FG and EH are the top views of the left mirror, the right mirror, the front end and the rear end, respectively (FIG. 9), the plane passing through the front end of the STM was defined as the projection plane or image plane. Any thing the real camera C can see (in the angular sector bounded by CF and CG) will be projected onto the image plane between F and G. Therefore, FG is also the top view of the scene image (central view). Vₗ and Vᵣ are locations of the virtual cameras with respect to the left mirror and the right mirror, respectively. Anything the virtual camera Vₗ could see (in the angular sector bounded by VₗE and VₗF) was projected onto the image plane as the left view. KF is the top view of that image. Similarly, anything the virtual camera Vᵣ can see (in the angular sector bounded by VᵣH and VᵣG) will be projected onto the image plane as the right view. GL′ is the top view of that image.

Points I, J, Y and Z play important roles here. They are the four vertices of the trinocular region IZJY. If a point is outside this region, it can be seen by the real camera C, but not by virtual camera Vₗ or Vᵣ, or both. Such a point will not appear in the left view or the right view, or both. Consequently, one will not be able to find one of the to corresponding points (or both) for such a point in the generation of a stereoscopic image or in the computation of the depth value. In general, to ensure enough information is obtained for stereoscopic image generation or depth computation, the scene to be shot by the real camera should be inside the trinocular region. Hence, a good STM should make the distance between I and J long enough and the width between Y and Z wide enough. These points can be computed as follows.

Let the distance between O and I be k and the distance between N and J be m. Since triangle VₗCI is similar to triangle EOI, we have

$$\frac{2 r}{r} = \frac{d + k}{k} .$$

Hence, k=d.

To compute J, note that triangle VₗCJ is similar to triangle FNJ. Hence, we have

$$\frac{2 r}{r} = \frac{d + l + m}{m}$$

or m=d+l. Therefore, the distance between I and J is 2l.

To compute Y, note that this is the intersection point of rays VₗF and VᵣH which can be parameterized as follows:

L(t)=Vₗ+t(F−Vₗ)t ∈ R

L₁(s)=Vᵣ+s(H−Vᵣ)s ∈ R

The intersection point is a point where L(t₁)=L₁(s₁) for some t₁ and s₁. By imposing a coordinate system on the STM with O as the origin, OH as the positive x-axis and OC as the positive z-axis, we have

$$\begin{matrix}\begin{matrix}L ( {t}_{1} ) = {V}_{l} + {t}_{1} ( F - {V}_{l} ) \\ = ( - 2 r , 0 , d ) + {t}_{1} [ ( - r , 0 , - l ) - ( - 2 r , 0 , d ) ] \\ = ( - 2 r + {t}_{1} r , 0 , d - {t}_{1} ( d + l ) )\end{matrix} \\ and \\ \begin{matrix}{L}_{1} ( {s}_{1} ) = {V}_{r} + {s}_{1} ( H - {V}_{r} ) \\ = ( 2 r , 0 , d ) + {s}_{1} [ ( r , 0 , 0 ) - ( 2 r , 0 , d ) ] \\ = ( 2 r - {s}_{1} r , 0 , d - {s}_{1} d )\end{matrix}\end{matrix}$$

For L(t₁) to be the same as L₁(s₁), we must have

−2r+t₁r=2r−s₁r

d−t₁(d+l)=d−s₁d

Solving this system of linear equations, we get t₁=4d/(2d+l) and, consequently,

$$\begin{matrix}Y = L ( {t}_{1} ) \\ = ( - 2 r + \frac{4 rd}{2 d + l} , 0 , d - \frac{4 d ( d + l )}{2 d + l} ) \\ = ( \frac{- 2 rl}{2 d + l} , 0 , \frac{- d ( 2 d + 3 l )}{2 d + l} ) .\end{matrix}$$

Using property of symmetry, we have

$$Z = ( \frac{2 rl}{2 d + l} , 0 , \frac{- d ( 2 d + 3 l )}{2 d + l} )$$

Hence, the width between Y and Z is 4rl(2d+l). Summarizing the above results, we have

I=(0,0,−d);

J=(0,0,−d−2l)

|IJ|=2l;

$$\vert YZ \vert = \frac{4 rl}{2 d + l}$$

These are important results because they tell us how a parallel STM should be designed.

First, to ensure the trinocular region IZJY can be used for scene shooting as much as possible, point I should be inside the region GRQF (see FIG. 9) instead of the STM, i.e., I should be to the right of N. Since z-component of 1 is −d and z-component of N is −l, this means that d should be greater than l. However, one should not make d too large because large d (not even excessively) could cause FOV of the camera to cover too much extra space other than the STM itself such as the areas to between K and W, and X and L in FIG. 9. These areas do not contain information related to the scene and, therefore, are of no use to the 3D image generation process.

The distance between Y and Z and the locations of Y and Z actually are more critical in most of the applications because they determines if a scene can fit into the trinocular region IZJY. To ensure the widest part of the trinocular region can be used for the given scene, these points must be to the right of N, i.e.,

$$\frac{- d ( 2 d + 3 l )}{2 d + l} < - l or d > \frac{1}{2} .$$

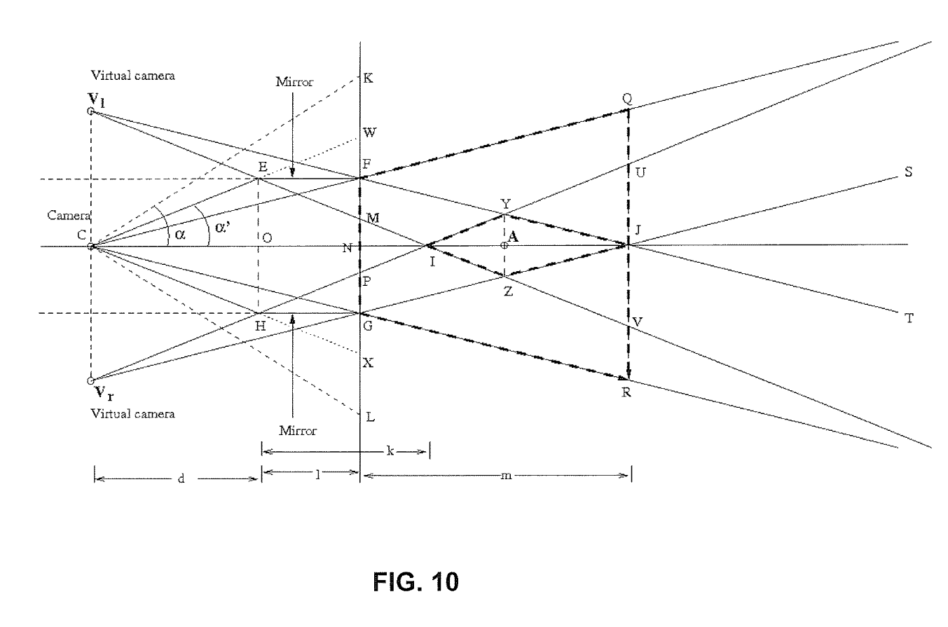

An example with d>l/2 is shown in FIG. 10. Since d is smaller than l here, the apex of the trinocular region, I, is inside the STM while Y and Z are to the right of N. Actually it is easy to see that when l/2<d<l, we have

$$2 r > \frac{4 rl}{2 d + l} > \frac{4 r}{3}$$

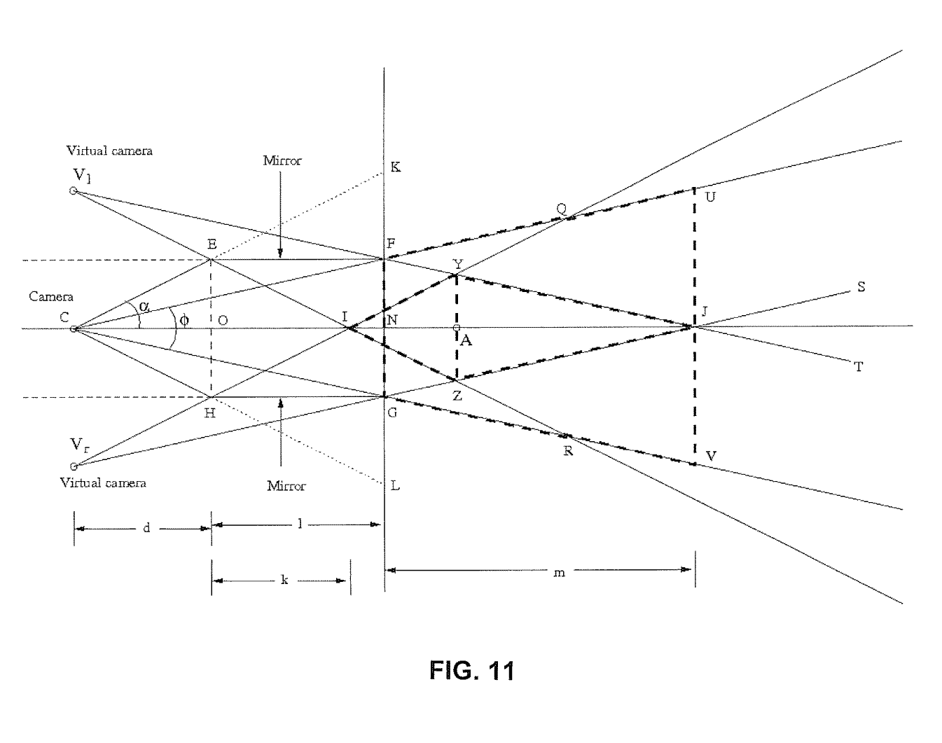

Hence, one can increase the distance between Y and Z (width of the trinocular region) by increasing the value of r (see FIG. 11 for an example). However, it should be pointed out that increasing the value of r would reduce the coverage of the STM by the FOV of the camera (see FIG. 11) and, consequently, reduce the size of the left view and the right view (actually the upper view and the lower view as well). Actually, if r satisfies the following condition

r≧(d+l)tan α

one will not get a left view or a right view at all because in such a ease 2α would be smaller than the effective FOV of the camera, φ.

Based on the above analysis, we can see that when the scene is close to the STM, one can use most of the trinocular region IZJY for scene shooting if l/2<d. One can increase the length of the trinocular region IZJY by increasing the length of the STM and increase its width by increasing the value of r. In general, a parallel STM was found suitable for imaging scenes close to the STM only.

b. Sloped STM

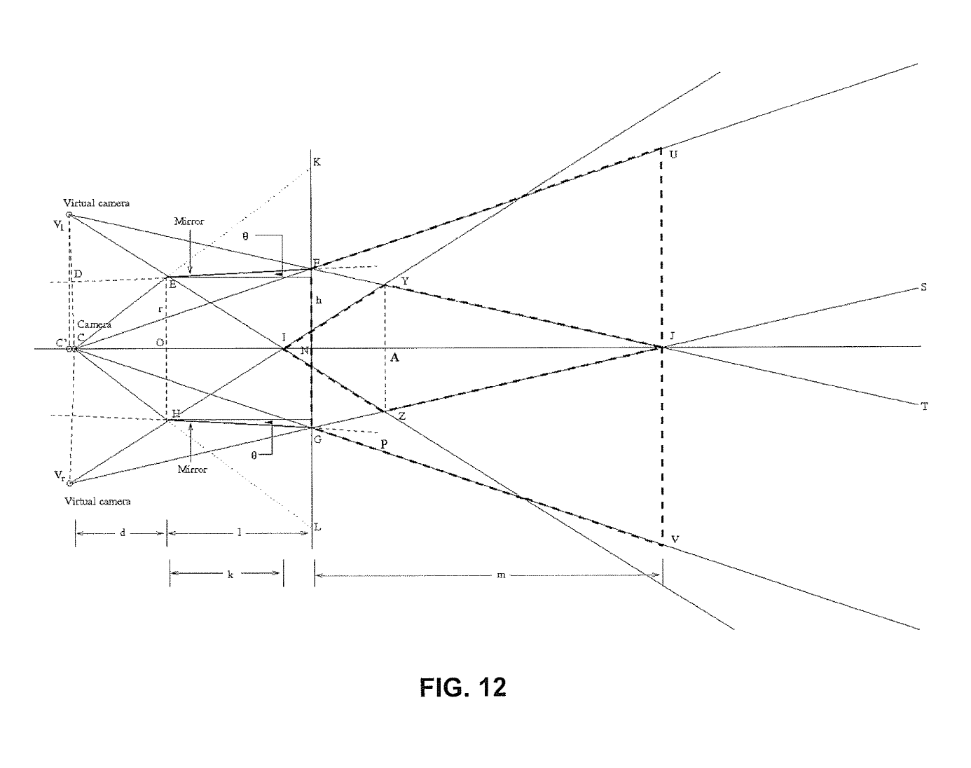

We next considered the case that the four interior sides of the STM make a positive angle θ with the optical center of the STM (and, therefore, the front of the STM closest to the image is larger than its rear closest to the camera). We refer to this case as sloped STM. An example is shown in FIG. 12. In the following, we will develop/show design criteria for STMs of this type.

We assume O is the origin of the 3D coordinate system, i.e., O=(0,0,0), the optical center of the STM is the z-axis with C being in the positive direction, and OH is the positive x-axis. Hence, we have C=(0,0,d), E=(−r,0,0). In FIG. 12, CD′ is perpendicular to OC and D′E′ is perpendicular to OE. Therefore, |E′|=|D′E′|tan θ=d tan θ and, consequently,

|CD′|=|EO|−|EE′|=r−d tan θ

Since |CD|=|CD′|cos θ, it follows that

D=(−Δ cos θ,0,d+Δ sin θ)

where Δ=r cos θ−d sin θ. We get Vₗ as follows:

Vₗ=(−2Δ cos θ,0,d+2Δ sin θ)

because the length of VₗC is twice the length of DC.

With the location of Vₗ available, we can now compute the locations of I, J Y and Z. This can be done using properties of similar triangles or ray intersection.

First note that triangle VₗC′I is similar to triangle EOI. Therefore we have

$$\frac{\vert {V}_{t} {C}^{′} \vert}{\vert EO \vert} = \frac{\vert {C}^{′} I \vert}{\vert OI \vert} or \frac{2 Δ cos θ}{r} = \frac{2 Δ sin θ + d + - \vert OI \vert}{\vert OI \vert}$$

where Δ=r cos θ−d sin θ. A simple algebra shows that

$$\vert OI \vert = \frac{r ( d + 2 Δ sin θ )}{2 Δ cos θ - r}$$

Hence,

$$I = ( 0 , 0 , - \frac{r ( d + 2 Δ sin θ )}{2 Δ cos θ - r} )$$

To compute J, note that J exists only if the rays VₗF and VᵣG intersect. This would happen only if the distance between the virtual cameras and the z-axis is bigger than h, i.e., 2Δ cos θ>h. Otherwise, we have a trinocular region that is extended to infinity. Here we assume that 2Δ cos θ>h. In this case, triangle VₗC′J is similar to triangle FNJ. Hence, we have

$$\frac{\vert {V}_{l} {C}^{′} \vert}{\vert F N \vert} = \frac{\vert {C}^{′} J \vert}{\vert N J \vert} or \frac{2 Δcos θ}{h} = \frac{2 Δsin θ + d + l + \vert N J \vert}{\vert N J \vert}$$

where Δ=r cos θ−d sin θ. Again, a simple algebra gives us

$$\vert N J \vert = \frac{h ( d + l + 2 Δsin θ )}{2 Δcos θ - h}$$

$$and$$

$$\begin{matrix}\vert O J \vert = l + \vert N J \vert \\ = \frac{2 l Δcos θ + dh + 2 h Δsin θ}{2 Δcos θ - h} \\ = - d + \frac{2 Δcos θ ( d + l + h tan θ )}{2 Δcos θ - h} .\end{matrix}$$

Therefore, we have

$$\begin{matrix}J = ( 0 , 0 , - \frac{2 l Δcos θ + dh + 2 h Δsin θ}{2 Δcos θ - h} ) \\ = ( 0 , 0 , d - \frac{2 Δcos θ ( d + l + h tan θ )}{2 Δcos θ - h} )\end{matrix}$$

Note that when θ=0, we have h=r and Δ=r. Hence, when θ=0, the above equations reduce to I=(0,0,−d) and J=(0,0,−d−2l), respectively.

Y is computed as the intersection points of the ray VₗF and ray VᵣH. These rays can he parameterized as follows:

$$\begin{matrix}L ( t ) = {V}_{l} + t ( F - {V}_{l} ) \\ = \begin{matrix}( - 2 Δ cos θ , 0 , d + 2 Δsinθ ) + \\ t [ ( - h , 0 , - l ) - ( - 2 Δ cos θ , 0 , d + 2 Δsinθ ) ]\end{matrix} \\ = ( \begin{matrix}- 2 Δ cos θ + t ( 2 Δcos θ - h ) , 0 , d + \\ 2 Δsin θ - t ( d + l + 2 Δsin θ )\end{matrix} )\end{matrix}$$

$$and$$

$$\begin{matrix}{L}_{1} ( s ) = {V}_{r} + s ( H - {V}_{r} ) \\ = \begin{matrix}( 2 Δ cos θ , 0 , d + 2 Δsinθ ) + \\ s [ ( r , 0 , 0 ) - ( 2 Δ cos θ , 0 , d + 2 Δsinθ ) ]\end{matrix} \\ = ( \begin{matrix}2 Δ cos θ - s ( 2 Δcos θ - r ) , 0 , d + \\ 2 Δsin θ - s ( d + 2 Δsin θ )\end{matrix} )\end{matrix}$$

We need to find parameters t₁ and s₁ such that L(t₁)=L₁(s₁). To have L(t₁)=L₁(s₁), we must have

−2Δ cos θ+t₁(2Δ cos θ−h)=2Δ cos θ−s₁(2Δ cos θ−r)

d+2Δ sin θ−t₁(d+l+2Δ sin θ)=d+2Δ sin θ−s₁(d+2Δ sin θ)

or

t₁(2Δ cos θ−h)+s₁(2Δ cos θ−r)=4Δ cos θ

−t₁(d+l+2Δ sin θ)+s₁(d+2Δ sin θ)=0

Solving this system of linear equations, we first get

$${s}_{1} = \frac{{t}_{1} ( d + l + 2 Δsin θ )}{d + 2 Δsin θ}$$

and then

$${t}_{1} = \frac{4 Δcos θ ( d + 2 Δsin θ )}{{Δ}_{1} + {Δ}_{2}}$$

where

Δ₁=(d+2Δ sin θ)(2Δ cos θ−h)

Δ₂=(2Δ cos θ−r)(d+l+2Δ sin θ)

Note that Δ₁ and Δ₂ are the areas of the rectangles VₗD′″E″E′″ and VₗD″F′F″ respectively. Hence, Y can be expressed as follows:

$$\begin{matrix}Y = L ( {t}_{1} ) \\ = {V}_{l} + {t}_{1} ( F - {V}_{l} ) \\ = ( \begin{matrix}- 2 Δcos θ + \frac{4 Δcos {θΔ}_{1}}{{Δ}_{1} + {Δ}_{2}} , 0 , d + 2 Δsin θ - \\ \frac{4 Δcos θ ( d + 2 Δsin θ ) ( d + l + 2 Δsin θ )}{{Δ}_{1} + {Δ}_{2}}\end{matrix} )\end{matrix}$$

where Δ₁ and Δ₂ are defined as above. With the expression of Y available, we know the width of the trinocular region is

$$\vert YZ \vert = 2 \vert YA \vert = 2 \vert {( Y )}_{r} \vert = \frac{4 Δ ( {Δ}_{2} - {Δ}_{1} ) cos θ}{{Δ}_{1} + {Δ}_{2}}$$

and it occurs at

$${( Y )}_{z} = \frac{( d + 2 Δsin θ ) ( {Δ}_{1} - {Δ}_{2} - 2 {Δ}_{3} )}{{Δ}_{1} + {Δ}_{2}}$$

where

Δ₃=r(d+l+2Δ sin θ)

and Δ₁ and Δ₂ are defined as above. Δ₃ is the area of the rectangle D″C′NF′.

An important criterion in the design of a sloped STM is: how do we want the trinocular region of the sloped STM to be? For a parallel STM, the length of the trinocular region is always finite because the rays VₗF and VᵣG always intersect and, therefore, the point J always exist. This is not the case for sloped STMs. Consider, for example, a sloped STM. In this case, ray VₗF and ray VᵣG do not intersect in the negative z direction. Therefore, the trinocular region is unbounded on the right hand side. This means when using a sloped STM to shoot a picture, one has the advantage of handling scenes with large depth.

In the case of a bounded trinocular region, the distance between a virtual camera and the z-axis (optical center of the STM) must be bigger than h, i.e., 2Δ cos θ>h. To ensure this is true, first note that r, d and α are related in the following sense:

$$\frac{r}{d} = tan α or d = \frac{r}{tan α}$$

Therefore, for 2Δ cos θ>h, we must have

2(r cos θ−d sin θ)cos θ>r+l tan θ

or

$$\frac{r}{l} > \frac{sin α tan θ}{sin ( α - 2 θ )}$$

So, in this case, we expect

α−2θ>0 or α>2θ

It is easy to see that in this case we have

$$\vert I J \vert = \frac{l ( 2 Δcos θ ) [ tan θ ( d + 2 Δsin θ ) + 2 Δcos θ - r ]}{( 2 Δcos θ - r ) ( 2 Δcos θ - h )}$$

Hence, in this case, one can use the above equations to adjust the parameters r, d, θ and l to construct a trinocular region that would meet our requirements.

In the case of an unbounded trinocular region, the distance between a virtual camera and the z-axis (optical center of the STM) must be smaller than h, i.e., 2Δ cos θ<h. In this case one can still use the above equations to adjust the width and location of the trinocular region. However, since the relationship between r and d is fixed, one should mainly use the other two parameters (θ,l) to adjust the shape and location of the trinocular region. Actually the best parameter to use is l because adjusting this parameter will not affect the size of the left view and the right view much while adjusting the parameter θ will.

Image-Plus-Depth

A. Computing Corresponding Points

a. Imager (Camera) Calibration

For image reconstruction it was first necessary to effect camera calibration to obtain camera parameters for the reconstruction process. The calibration technique described follows a prior art approach [Z. Zhang. A flexible new technique for camera calibration. IEEE Transactions on Pattern Analysis and Machine Intelligence, 22(11):1330-1334, 2000].

A 2D and a 3D point were denoted by m=[u,v]^{T} and M=[x,y,z]^{T}, respectively. They can also be represented in homogeneous coordinates as \tilde{m}=[u,v,1]^{T} and \tilde{M}=[x,y,z,1]^{T}, respectively. The camera was considered as a pinhole, so the relationship between a 3D point M and its projected image in was given by

s\tilde{m}=A[R t]\tilde{M}, (12)

where s is a scaling factor, [R,t] is the rotation and translation matrix which relates the world coordinate system with the camera coordinate system. R and t are called the extrinsic parameters. A, called the camera intrinsic matrix, is given by

$$A = [ \begin{matrix}α & γ & {u}_{0} \\ 0 & β & {v}_{0} \\ 0 & 0 & 1\end{matrix} ]$$

with (u₀,v₀) being coordinates of the principal point. The principle point is the intersection of the optical axis and the image plane. α and β are scaling factors in u and v axes of the image plane and γ is the parameter describing the skewness of the two image axes. Note that α and β are related to the focal length f.

In the calibration process, the camera needs to observe a planar pattern shown in a few different orientations. The plane in which the pattern lies is called the model plane, set to be the Z=0 plane of the world coordinate system. The i^{th} column of the rotation matrix R is denoted by rₗ. From (12), we have

$$s [ \begin{matrix}u \\ v \\ 1\end{matrix} ] = A [ {r}_{t} {r}_{2} {r}_{3} t ] [ \begin{matrix}X \\ Y \\ 0 \\ 1\end{matrix} ] = A [ {r}_{1} {r}_{2} t ] [ \begin{matrix}X \\ Y \\ 1\end{matrix} ]$$

i.e., a point M in the model plane can be expressed as M=[X,Y]^{T} since Z is always 0. In turn, M=[X,Y,l]^{T}. Therefore, a model point M and its image in are related by a homography H:

s\tilde{m}=H \tilde{M} with H=A[r₁,r₂,t]. (13)

The 3×3 matrix H is defined up to a scaling factor.

The homography, denoted H=[h₁,h₂,h₃], was estimated with an image of the model plane. Note that from (13), we have

[h₁ h₂ h₃]=λA[r₁ r₂ t],

where λ is a scaling factor. Using the property that r₁ and r₂ are orthonormal, we have

h₁^{T}A^{-T}A⁻¹h₂=0 (14)

h₁^{T}A^{-T}A⁻¹h₁=h₂^{T}A^{-T}A⁻¹h₂. (15)

These are the two basic constraints on the intrinsic parameters, given one homography. Because a homography has 8 degrees of freedom and there are 6 extrinsic parameters (3 for rotation and 3 for translation), we can only obtain 2 constraints on the intrinsic parameters.

Lens distortion was ignored to make the computation simpler.

It is easy to see the inverse of A is

$${A}^{- 1} = [ \begin{matrix}1 / α & - γ / ( αβ ) & ( - {u}_{0} β + γ {v}_{0} ) / ( αβ ) \\ 0 & 1 / β & - {v}_{0} / β \\ 0 & 0 & 1\end{matrix} ] \\ Let \\ \begin{matrix}B = {A}^{- T} {A}^{- 1} \\ = [ \begin{matrix}{B}_{11} & {B}_{12} & {B}_{13} \\ {B}_{21} & {B}_{22} & {B}_{23} \\ {B}_{31} & {B}_{32} & {B}_{33}\end{matrix} ] \\ = [ \begin{matrix}\frac{1}{{α}^{2}} & \frac{- γ}{{α}^{2} β} & \frac{γ {v}_{0} - {u}_{0} β}{{α}^{2} β} \\ \frac{- γ}{{α}^{2} β} & \frac{{γ}^{2}}{{α}^{2} {β}^{2}} + \frac{1}{{β}^{2}} & \frac{- γ ( γ {v}_{0} - {u}_{0} β )}{{α}^{2} {β}^{2}} - \frac{{v}_{0}}{{β}^{2}} \\ \frac{γ {v}_{0} - {u}_{0} β}{{α}^{2} β} & \frac{- γ ( γ {v}_{0} - {u}_{0} β )}{{α}^{2} {β}^{2}} - \frac{{v}_{0}}{{β}^{2}} & \frac{{( γ {v}_{0} - {u}_{0} β )}^{2}}{{α}^{2} {β}^{2}} + \frac{{v}_{0}^{2}}{{β}^{2}} + 1\end{matrix} ]\end{matrix} \qquad ( 16 )$$

Note that B is symmetric. We define b, a 6D vector, as follows:

b=[B₁₁, B₁₂, B₂₂, B₁₃, B₂₃, B₃₃]^{T}. (17)

Recall that hᵢ denotes the i^{th} column vector of H. Then we have

hᵢ^{T}Bhᵢ=vᵢᵢ^{T}b (18)

with

vᵢⱼ=[h₁ᵢh₁ⱼ,h₁ᵢh₂ⱼ+h₂ᵢh₁ⱼ,h₂ᵢh₂ⱼ,h₃ᵢh₁ⱼ+h₁ᵢh₃ⱼ,h₃ᵢh₂ⱼ+h₂ᵢh₃ⱼ,h₃ᵢh₃ⱼ]^{T}

Therefore, (14) and (15) can be rewritten as:

$$[ \begin{matrix}{v}_{12}^{T} \\ {( {v}_{11} - {v}_{22} )}^{T}\end{matrix} ] b = 0. \qquad ( 19 )$$

If we have n images of the model plane, by stacking n such equations as (19) we have

Vb=0, (20)

where V is a 2n×6 matrix. If n≧3, we will have in general a unique solution b defined up to a scaling factor. Usually we take 7-15 pictures of the pattern and use around 10 images for calibration to obtain a more accurate result. The solution to (20) is the eigenvector of V^{T}V associated with the smallest eigenvalue.

Once b is estimated, A can be computed as follows:

α=\sqrt{1/B₁₁}

β=1/\sqrt{B₂₂−(αB₁₂)²}

γ=−α²βB₁₂

ν₀={square root over (β²(B₃₃−(αB₁₃)²−1))}

u₀=(γv₀−α²βB₁₃)/β.

Once A is computed, we can compute the extrinsic parameters for each image:

r₁=λA⁻¹h₁;

r₂=λA⁻¹h₂;

r₃=r₁×r₂;

t=λA⁻¹h₃

Here,

$$λ = \frac{1}{{A}^{- 1} {h}_{1}} = \frac{1}{{A}^{- 1} {h}_{2}} .$$

Since the virtual cameras had the same intrinsic parameters as the real camera, only one camera calibration was needed. Correspondences were selected by using a feature point based matching process. Surprisingly, it was found that building a 3D representation did not require calculating the depth of all pixels.

b. Obtaining Correspondence Between Views

With the camera parameters being known, the only challenge left was to find the correspondence between the views. Unfortunately, reliable identification of corresponding points between different views is a very difficult problem, especially with objects having solid colors or specular reflection, such as human teeth. To address this problem, in addition to the classic vision matching technique such as cross-correlation, feature points were also used in the matching process to achieve better results. Specular reflection was removed from each point of the given image, and intensity of each point in the left view, right view, upper view and lower view was divided by 78%.

The Canny edge detection algorithm [Canny, J., A Computational Approach To Edge Detection, IEEE Trans. Pattern Analysis and Machine Intelligence, 8:679-714, 1986] is considered in the art to be an optimal edge detector. The purpose of the method is to detect edges with noise suppressed at the same time. The Canny Operator has the following goals:

(a) Good Detection: the ability to locate and mark all real edges.

(b) Good Localization: minimal distance between the detected edge and real edge.

(c) Clear Response: only one response per edge.

The approach is based on convoluting the image function with Gaussian operators and their derivatives. This is a multi-step procedure.

The Canny Operator sets two thresholds to detect the edge points. The six steps are as follows:

Step 1. Noise Reduction

First, the image is convolved with a discrete Gaussian filter to eliminate noise. The discrete Gaussian filter is typically a 5×5 matrix of the following form (for σ=1.4):

$$G = \frac{1}{159} [ \begin{matrix}2 & 4 & 5 & 4 & 2 \\ 4 & 9 & 12 & 9 & 4 \\ 5 & 12 & 15 & 12 & 5 \\ 4 & 9 & 12 & 9 & 4 \\ 2 & 4 & 5 & 4 & 2\end{matrix} ]$$

If f(m,n) is the given image, then the smoothed image F(m,n) is computed as follows:

$$F ( m , n ) = G ( m , n ) * f ( m , n ) = {\sum }_{i = 0}^{4} {\sum }_{j = 0}^{4} G ( i , j ) f ( m - i , n - j )$$

Step 2. Finding the Intensity Gradient of the Image

This step finds the edge strength by taking the gradient of the image. This is done by performing convolution of F(m,n) with Gₓ and G_{y}, respectively,

Eₓ(m,n)=Gₓ*F(m,n);

E_{y}(m,n)=G_{y}*F(m,n)

where

$${G}_{x} = [ \begin{matrix}- 1 & 0 & 1 \\ - 2 & 0 & 2 \\ - 1 & 0 & 1\end{matrix} ]$$

$${G}_{y} = [ \begin{matrix}1 & 2 & 1 \\ 0 & 0 & 0 \\ - 1 & - 2 & - 1\end{matrix} ]$$

and then computing the gradient

A(m,n)={square root over (Eₓ(m,n))²+(E_{y}(m,n))²)}

Step 3. Finding the Edge Direction

This step is trivial once gradients in the X and Y directions are known. The direction is

$$θ ( m , n ) = {tan}^{- 1} ( \frac{{E}_{y} ( m , n )}{{E}_{x} ( m , n )} )$$

However, we will generate an error whenever Eₓ is zero. So in the code, there has to be a restriction set whenever this takes place. Whenever Eₓ is zero, the edge direction is set to 90 degrees or 0 degrees, depending on what value E_{y} is equal to. If E_{y}=0, the edge direction is set to 0. Otherwise, it is set to 90.

Step 4. Rounding the Edge Directions

This step relates each edge direction to a direction that can be traced in an image. Note that there are only four possible directions for each pixel: 0 degrees, 45 degrees, 90 degrees, or 135 degrees. So edge direction of each pixel has to be resolved into one of these four directions, depending on which direction it is closest to. An edge direction that is between 0 and 22.5 or 157.5 and 180 degrees is set to 0 degrees. An edge direction that is between 22.5 and 67.5 is set to 45 degrees. An edge direction that is between 67.5 and 112.5 degrees is set to 90 degrees. An edge direction that is between 112.5 and 157.5 degrees is set to 135 degrees.

Step 5. Non-Maximum Suppression

This step performs a search to determine if the gradient magnitude assumes a local maximum in the gradient direction. So, for example,
if the rounded angle is zero degrees the point will be considered to be on the edge if its intensity is greater than the intensities in the north and south directions,
if the rounded angle is 90 degrees the point will be considered to be on the edge if its intensity is greater than the intensities in the west and east directions,
if the rounded angle is 135 degrees the point will be considered to be on the edge if its intensity is greater than the intensities in the north east and south west directions.
if the rounded angle is 45 degrees the point will be considered to be on the edge if its intensity is greater than the intensities in the north west and south east directions.

This is worked out by passing a 3×3 grid over the intensity map.

This step produces a set of edge points in the form of a binary image by suppressing any pixel value (setting it to 0) that is not considered to be an edge.

Step 6. Edge Tracing Through Hysteresis Thresholding

This step uses thresholding with hysteresis to trace edges. Thresholding with hysteresis requires 2 thresholds, high and low. The high threshold is used to select a start point of an edge and the low threshold is used to trace an edge from a start point. Points of the traced edges are then used as feature points subsequently to their corresponding points.

The above process was improved to obtain edges with sub-pixel accuracy by using second-order and third-order derivatives computed from a scale-space representation in the non-maximum suppression step.

Each view (area) of the grid image of FIG. 3 was labeled (FIG. 9). Area 0 was the real image; areas 1, 2, 3 and 4 were images reflected once by the upper, left, right and lower mirrors, respectively; areas 5, 6, 7 and 8 are the images reflected twice by the minors. The geometry of these reflections will be discussed below. On scanline L, there were two points A and B, with their corresponding points in area 3 being A1 and B1, respectively, and A2 and B2 in area 2, respectively. A3 and A4 are the corresponding point of A in areas 4 and 1. The corresponding points in our system satisfy the following constraints:

(1). Ordering Constraint: For opaque surfaces the order of neighboring correspondences on the corresponding epipolar line is always reversed. For example, if the indices of A and B on the scanline L satisfy the condition: (A)ₓ>(B)ₓ, then we must have (B1)ₓ>(A1)ₓ and (B2)ₓ>(A2)ₓ. This is because the mirror reflection reverses the image.

(2). Disparity Limit: The search band is restricted along the epipolar line because the observed scene has only a limited depth range. For example, if we are looking for the corresponding point of A in area 2, we don't need to search the entire scanline in area 2, we only need to search pixels in a certain threshold depending on the depth range.

(3). Variance limit: The differences of the depths computed using the corresponding points in the adjacent areas should be less than a threshold. For example, A1, A2, A3, A4 each can be used as a corresponding point of A and to compute a depth of A. We compute the variances of the four depths and they must be smaller than a threshold. Otherwise at least one of the depths is wrong.

After feature point determination, correspondences of these points were found using stereo matching approaches. Two intensity based approaches for stereo matching were considered:

Normalized cross-correlation [J. P. Lewis, “Fast Template Matching”, Vision Interface, p. 120-123, 1995] is an effective and simple method to measure similarity. In our application, the reflected images have reduced intensity values than the central view because of the non-perfect reflection factors of the mirrors. But normalized cross-correlation is invariant to linear brightness and contrast variations. This approach provided good matching results for our feature points.

The use of cross-correlation for template matching was motivated by squared Euclidean distance:

$${d}_{f , g}^{2} ( x , y ) = {\sum }_{i , j} {[ f ( i , j ) - g ( i - x , j - y ) ]}^{2}$$

where f is the source image in the region and the sum is over i,j under the region of destination image g positioned at (x,y).

Here we expand d²:

$${d}_{f , g}^{2} ( x , y ) = \sum ⌊ {f}^{2} ( i , j ) - 2 f ( i , j ) g ( i - x , j - y ) + {g}^{2} ( i - x , j - y ) ⌋$$

The term

$$\sum {g}^{2} ( i - x , j - y )$$

is a constant. If the term

$$\sum {f}^{2} ( i , j )$$

is approximately a

constant then the remaining cross-correlation term

$$c ( x , y ) = {\sum }_{i , j} f ( i , j ) g ( i - x , j - y ) \qquad ( 21 )$$

is a measure of the similarity between the source image and the destination image.

Although (21) is a good measure, there are several disadvantages to use it for matching:

1). If the image energy

$$\sum {f}^{2} ( i , j )$$

varies with position, matching using (21) can fail. For example, the correlation between the destination image and an exactly matching region in the source image may be less than the correlation between the destination image and a bright spot.

2). The range of c(x,y) is dependent on the size of the region.

3). Equation (6-10) is not invariant to changes in image amplitude such as those caused by changing lighting conditions across the image sequence.

The correlation coefficient overcomes these difficulties by normalizing the image and feature vectors to unit length, yielding a cosine-like correlation coefficient:

$$N ( x , y ) = \frac{\sum ⌊ f ( i , j ) - {f}_{x , y} ⌋ [ g ( i - x , j - y ) - t ]}{{[ \sum {[ f ( i , j ) - {f}_{x , y} ]}^{2} \sum {[ g ( i - x , j - y ) - t ]}^{2} ]}^{1 / 2}} \qquad ( 22 )$$

where t is mean of the destination image in the region and f_{x,y} is mean of f(i,j) in the region under the feature. (22) is what we referred to as the normalized cross-correlation.

The corresponding points in the source image and the destination image did not lie on the same scanline, but satisfied certain condition. The intensity profiles from the corresponding segments of the image pair differed only by a horizontal shift and a local foreshortening. The similarity of the image pair was continuous, and therefore an optimization process was considered suitable. A prior art attempt to match parallel stereo images using simulated annealing [Barnard, S. T. (1987), Stereo Matching by Hierarchical, Microcanonical Annealing, Int. Joint Conf. on Artificial Intelligence, Milan, Italy, pp. 832-835] defined an energy function as:

Eᵢⱼ=|I_{L}(i,j)−I_{R}(i,j)+D(i,j)|+λ|ΔD(i,j)|

where I_{L}(i,j) denotes the intensity value of the source image at (i,j), and I_{R}(i,k) denotes the intensity value of the destination image at the same row but at the k-th column; D(i,j) is the disparity value (or horizontal shift in this case) at the ij-position of the source image. So this was a constrained optimization problem in which the only constraint being used is a minimum change of disparity values D(i,j).

c. Distance Between Imager (Camera) and STM

A parameter that was important both in the design of an STM and in the 3D image computation is d, the distance between the pinhole of the camera and the STM. This distance was also needed in the computation of the locations of all virtual cameras. In practice, typically the bounding planes of a camera field of view (FOV) do not automatically pass through the boundary edges of the device rear because of hardware restrictions. Thus, it is necessary to compute the effective d. Two situations were considered: FOV of camera covers part of STM only or FOV of camera covers more than the entire STM.

If the camera FOV of the camera does not cover the entire STM, but only a portion of it, the bounding planes of the camera's FOV do not pass through the boundary edges of the STM's rear end, but intersect the interior of the STM (see FIG. 11). In FIG. 11, 2α is the FOV of the camera and Φ is the FOV of a virtual camera. E′ and H′ are the intersection points of the bounding planes of the Camera's FOV with (the horizontal cross-section of) the interior of the STM. O′ is the intersection point of E′H′ with the optical center of the STM. In this case, the vertical plane determined by E′H′ will be considered as the effective rear end of the STM and O′ is the center of the effective rear end of the STM. Hence, we need to compute the distance between C and O′ and the distance between O′ and N. These distances, denoted d′ and l′, are called the effective distance between the camera and the STM and the effective length of the STM.

First was the step of determination of the distance between U and F. This is the horizontal length of the virtual left view in the virtual image plane. Given an image shot with this STMIS configuration, if the horizontal resolutions of the central view and the left view are m and mₗ, respectively, then since the length of the virtual central view is 2h, it follows that the horizontal dimension of each virtual pixel in the virtual central view is 2h/m. There are mₗ virtual pixels between U and F. Therefore, the distance between U and F is

$$t = \frac{2 h}{m} {m}_{l}$$

With α, t and h known, it was possible to compute L, the distance between the camera and the front end of the STM, and d, the distance between the camera and the real rear end of the STM, as follows:

$$L = \frac{t + h}{tan α} ;$$

d=L−l

Once we have d, we can compute the distance between O and I, and the distance between E and I:

|OI|=d tan α;

|EI|=r−|OI|

Using property of similar triangles, we have

$$\frac{\vert {DE}^{′} \vert}{{l}^{′}} = \frac{\vert {EE}^{′} \vert}{\vert {E}^{′} F \vert} = \frac{\vert EI \vert}{t}$$

Hence,

$$\vert {DE}^{′} \vert = {l}^{′} \frac{\vert EI \vert}{t}$$

Note that |DE′|+l′=l or l′=l−|DE′|, the above equation can be expressed as

$$\vert {DE}^{′} \vert = ( l - \vert {DE}^{′} \vert ) \frac{\vert EI \vert}{t} = \frac{l}{t} \vert EI \vert - \vert {DE}^{′} \vert \frac{\vert EI \vert}{t}$$

Consequently,

$$\vert {DE}^{′} \vert = \frac{\vert EI \vert}{t + \vert EI \vert} l$$

And therefore,

d′=d+|DE′| (23)

(23) includes the ideal case as a special case when |DE′| equals zero.

The FOV of the camera may cover not only the entire STM, but also some extra space. In this situation, bounding planes of the FOV do not intersect the rear end or the interior of the STM, but an extension of the STM (see FIG. 12). In FIG. 12, 2α is the FOV of the camera, E′ and H′ are the intersection points of the bounding planes of the camera's FOV with (the horizontal cross-section of) an extension of the STM. In this case since the left view (corresponding to region between M and F) contains information not related to the scene, we will consider the effective left view (corresponding to region between U and F) only. Hence, we need to compute the distance between C and O, instead of C and O′. We also need to compute s, horizontal dimension of the effective left view. In FIG. 12, Π was called the effective FOV of the camera.

Given an image shot with this STMIS configuration, let the horizontal resolutions of the central view and the left view again be m and mₗ, respectively. Using a similar approach as above, we can again compute the horizontal dimension of the virtual left view (between M and F) as

t=(2h/m)mₗ.

With α, t and h known to us, we can compute L, the distance between the camera and the front end of the STM as follows:

$$L = \frac{t + h}{tan α} .$$

Hence,

d=L−l. (24)

With d available to us, we can compute the effective FOV as follows

$$Π = {tan}^{- 1} ( \frac{r}{d} )$$

Since

$$tan Π = \frac{s + h}{L}$$

Consequently,

s=−h+L tan Π. (25)

In the latter case, if the left edge of the effective left view between U and F is not easy to identify, one can consider a smaller effective left view. In one example, instead of using the angle Π as the effective FOV, a smaller angle such as Σ (FIG. 7) was used as the effective FOV. The choice of the angle Σ (and, hence, the point V) is not unique, it basically depends on if it is easy to create an artificial left edge through V for the smaller effective left view. In this case, like in case 2, one needs to compute the parameters L, d, Π and s first, then compute u, l″, d″ and r″. u is the horizontal dimension of the smaller effective left view, and l″, d″ and r″ are effective values of l, d and r, respectively.

Since Σ and L are known to us, by using the fact that tan Σ=(u+h)/L we have immediately that

u=L tan Σ−h

and, consequently, V was known.

To compute l″, note that triangle VE″J is similar to triangle VCN. Hence, we have

$$\frac{u + h}{u + v} = \frac{L}{{l}^{″}}$$

where v is the distance between F and J. On the other hand, since tan θ=v/l″, or v=l″ tan θ, we can solve the above equation with this information to get l″ as follows:

$${l}^{″} = \frac{Lu}{u + h - L tan θ} .$$

But then d″ and r″ are trivial:

d″=L−l″ and r″=d″ tan Σ.

It was also necessary to determine the location of the pinhole (nodal point) of the camera, C, using a pan head on top of a tripod. This was done using a known method [http://www.4directions.org/resources/features/qtyr_tutorial/NodalPoint.htm].

d. Depth Computation

Information obtained from the left view, the right view, the upper view and the bottom view was used to compute depth for each point of the central view of an STM image. This was possible because virtual cameras for these views can see the object point that projects to the given image point. Instead of the typical, two-stage computation process, i.e., computing the corresponding point and then the depth, the technique presented herein computes the corresponding point and the depth at the same time.

Given a point A in the central view of an STM image, let P₁ be its corresponding point in the virtual central view. It was assumed that the scene shot by the camera was inside the trinocular region of the STM. For a trinocular region with a J-point, the scene must be before the J-point to avoid losing information. If the trinocular region does not have a J-point, then the scene must be before an artificial J-point defined as follows

J=(0,0,(I)_{z}+λ[(Y)_{z}−(I)_{z}])

where (I)_{z} and (Y)_{z} are defined in (3-7) and (3-13), respectively, and λ is a constant between 2 and 4. This setting was to avoid processing an infinite array in the corresponding point computing process. Since the existence of a J-point is characterized by the value of 2Δ cos θ−h, one can combine (3-8) with the above definition to define a general J-point as follows:

$$\begin{matrix}J = ( 0 , 0 , d - \frac{2 Δ cos θ ( d + l + h tan θ )}{2 Δ cos θ - h} ) , if 2 Δ cos θ > h \\ = ( 0 , 0 , \frac{{Δ}_{1} [ 2 λΔ cos θ ( {Δ}_{1} - {Δ}_{2} ) - r ( {Δ}_{1} + {Δ}_{2} ) ]}{( 2 Δ cos θ - h ) ( 2 Δ cos θ - r ) ( {Δ}_{1} + {Δ}_{2} )} ) , otherwise .\end{matrix} \qquad ( 26 )$$

where Δ₁ and Δ₂ were defined as above, respectively. Therefore, if A is the image of a point P in the scene, then P must be a point between P₁ and P₂ where P₂ is the intersection point of the ray CP₁ with the J-plane (the plane that is perpendicular to the optical center (−z-axis) of the STM at the general J-point). If we know the 3D location of P then we know the depth of A. Unfortunately, with the central view alone, this is not possible because, for camera C, the entire line segment P₁P₂ is mapped to one point and, therefore, A can be the image of any point between P₁ and P₂. But this is not the case for the virtual cameras.

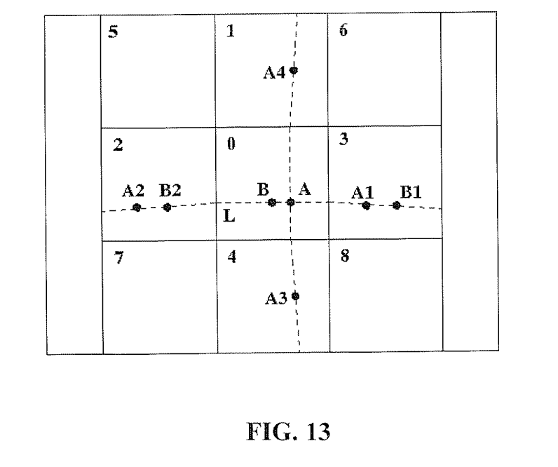

Consider, for instance, virtual camera Vᵣ (FIG. 12). Virtual camera Vᵣ can see all the points of the line segment P₁P₂. Therefore, for each point of P₁P₂ there is a corresponding point in the virtual right view. If P₁′ and P₂′ are the corresponding points of P₁ and P₂ in the virtual right view, respectively, then the corresponding point of P must be a point between P₁′ and P₂′. If P′ in FIG. 13 is the corresponding point of P between P₁′ and P₂′ then by following a simple inverse mapping process, we can find the location of P immediately and, consequently, the depth of A.

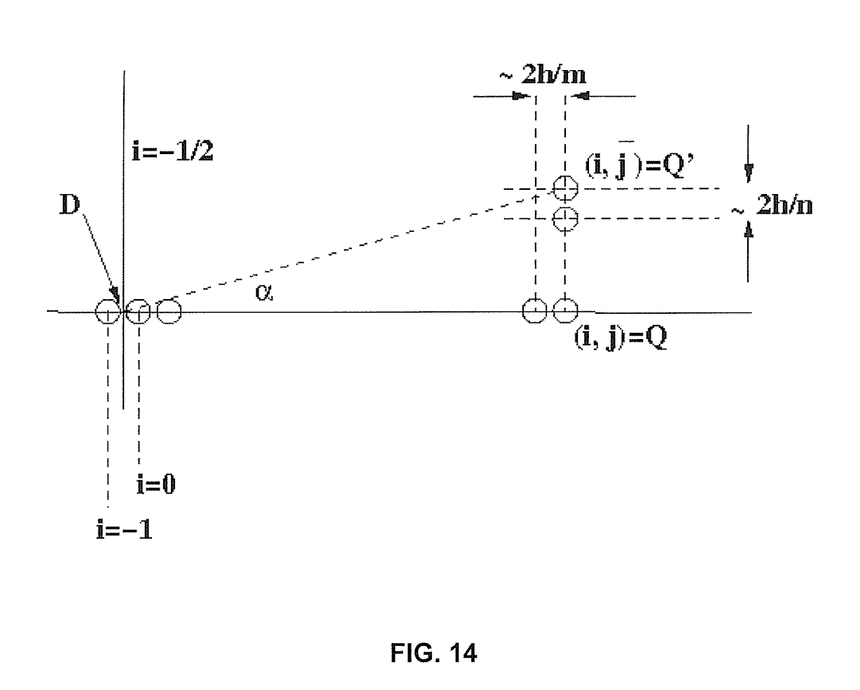

There are cases where the corresponding points can not be found in some views. Consider the example shown in FIG. 14. In this case, A is the image of the scene point P. However, since virtual camera Vᵣ can not see any points beyond P₃, P will not be projected to the virtual right view. Hence, in this case, constructing a reflection of P₁P₂ with respect to the mirror GH makes no sense at all. One needs to construct a reflection of P₁P₃ instead if P is a point between P₁ and P₃ (see FIG. 13). In the following, we show how to compute P₁ and P₂, P₁′ and P₂′, and then P′. In some cases, such as the one shown in FIG. 14, we will also compute P₃.

If the coordinates of A are (x,y), 0≦x≦m−1, 0≦y≦n−1, where in m×n is the resolution of the central view, then coordinates of P₁ would be (X,Y,−l) where

$$X = ( x - \frac{m}{2} ) \frac{2 h}{m} + \frac{h}{m} = ( x + \frac{1}{2} ) \frac{2 h}{m} - h$$

$$Y = ( y - \frac{n}{2} ) \frac{2 h}{n} + \frac{h}{n} = ( y + \frac{1}{2} ) \frac{2 h}{n} - h$$

P₂ can be computed as follows.

In FIG. 13, the ray CP₁ can be parameterized as follows:

L(t)=C+t(P₁−C)=(tX,tY,d−t(d+l))

where C=(0,0,d) is the location of the camera. To compute P₂ we need to find a parameter t₂ such that z-component of L(t₂) is the same as the z-component of J, i.e.,

$$\begin{matrix}d - {t}_{2} ( d + l ) = d - \frac{2 Δ cos θ ( d + l + h tan θ )}{2 Δ cos θ - h} , if 2 Δ cos θ > h \\ = \frac{{Δ}_{1} [ 2 λΔ cos θ ( {Δ}_{1} - {Δ}_{2} ) - r ( {Δ}_{1} + {Δ}_{2} ) ]}{( 2 Δ cos θ - h ) ( 2 Δ cos θ - r ) ( {Δ}_{1} + {Δ}_{2} )} , otherwise\end{matrix}$$

and then set P₂=L(t₂). Solving the above equation we get

$$\begin{matrix}{t}_{2} = \frac{2 Δ cos θ ( d + l + h tan θ )}{( l + d ) ( 2 Δ cos θ - h )} . if 2 Δ cos θ > h \\ = \frac{2 Δ cos θ [ \begin{matrix}( d + r tan θ ) ( {Δ}_{1} + {Δ}_{2} ) - \\ λ ( d + 2 Δ sin θ ) ( {Δ}_{1} - {Δ}_{2} )\end{matrix} ]}{( d + l ) ( 2 Δ cos θ - r ) ( {Δ}_{1} + {Δ}_{2} )} , otherwise\end{matrix} \qquad ( 27 )$$

Hence,

P₂=C+t₂(P₁−C)=(t₂X,t₂Y,d−t₂(d+l))

where t₂ is defined in (27). Note that t₂>2 if θ>0 in both cases.

However, there are occasions where computing P₂ is not necessary but rather computing P₃ is needed. In the following, we show how to compute P₃ for one case. The other cases can be done similarly.

Note that P₃ is the intersection point of the ray CP₁ with the plane that passes through the virtual camera Vᵣ=(2Δ cos θ,0,d+2Δ sin θ) and the two front corners of the right side mirror, (h,h,−l) and (h,−h,−l). The normal of that plane is (−d−l−2Δ sin θ,0,−h+2Δ cos θ). Therefore, to find P₃, we need to find a t₃ such that L(t₃)−(h,0,−l) is perpendicular to (−d−l−2Δ sin θ,0,−h+2Δ cos θ). We have

L(t₃)−(h,0,−l)=(t₃X−h,t₃Y,(d+l)(1−t₃))

To satisfy the condition (L(t₃)−(h,0,−l)·(−d−l−2Δ sin θ,0,−h+2Δ cos θ)=0, t₃ must be equal to

$${t}_{3} = \frac{2 Δ ( h sin θ + d cos θ + l cos θ )}{X ( d + l + 2 Δ sin θ ) + ( d + l ) ( 2 Δ cos θ - h )} \qquad ( 28 )$$

And we have P₃ as

P₃=(t₃X,t₃Y,d−t₃(d+l)).

In deciding when P₃ should be computed, if 2Δ cos θ>h compute P₃ when X≠0.

If 2Δ cos θ<h, compute P₃ when |X|> X̅ where

$$\overline{X} = \frac{( d + l ) ( d + l + 2 Δ sin θ ) ( {Δ}_{1} - {Δ}_{2} ) [ ( λ - 1 ) {Δ}_{1} - {Δ}_{2} ]}{( d + r tan θ ) ( {Δ}_{1} + {Δ}_{2} ) - λ ( d + 2 Δ sin θ ) ( {Δ}_{1} - {Δ}_{2} )} ,$$

Δ₁ and Δ₂ are defined as above, and λ is a constant between 2 and 4.

To compute the corresponding points of P₁ and P₂ (designated P′) in the virtual right view, we need to find the reflections of these points with respect to the right side mirror (the one that passes through GH; see FIG. 14. For simplicity, we shall simply call that mirror “mirror GH”) and then project these reflections onto the virtual image plane. We show construction of the reflections of these points with respect to mirror GH first.

The reflection of P₁P₂ can be constructed as follows. First, compute reflections of C and P₁ with respect to mirror GH. The reflection of C with respect to mirror GH is the virtual camera Vᵣ. Hence, we need to compute Vᵣ and Q₁, the reflection of P₁. The next step is to parameterize the ray VᵣQ₁ (see FIG. 13) as follows:

L₁(t)=Vᵣ+t(Q₁−Vᵣ), t≧0

The reflection of P₁P₂ is the segment of L₁(t) corresponding to the parameter subspace [1,t₂] where t₂ is defined in (27). More precisely, we have the following theorem.

THEOREM 2 For each point P=C +t(P₁−C), t ∈[1,t₂], of the segment P₁P₂, the reflection Q of P about the right mirror GH is

Q=L₁(t)=Vᵣ+t(Q₁−Vᵣ) (29)

for the same parameter t.

PROOF In the following we will show that this is indeed the case by constructing Vᵣ and Q₁ first. Note that virtual camera Vᵣ is symmetric to virtual camera Vₗ with respect to the yz-plane and coordinates of Vₗ are (−2Δ cos θ,0,d+2Δ sin θ). Hence, it follows immediately that Vᵣ=(2Δ cos θ,0,d+2Δ sin θ).

To compute Q₁ note that, from FIG. 13, the normalized normal of mirror GH is

$${N}_{r} = \frac{( l , 0 , h - r )}{\sqrt{{l}^{2} + {( h - r )}^{2}}} = ( cos θ , 0 , sin θ ) \qquad ( 30 )$$

Therefore, Q₁ can be expressed as P₁+αNᵣ where α is the distance between P₁ and Q₁. On the other hand, the distance between P₁ and the mirror GH is

σ₁=(h−X)cos θ (31)

and this distance is one half of the distance between P₁ and Q₁. Hence, we have

Q₁=P₁+2σ₁Nᵣ (32)

where σ₁ is defined in (31) and Nᵣ is defined in (30).

We now show that for a general point P=L(t)=C+t(P₁−C) in the line segment P₁P₂, the reflection Q is defined in (29). To show this, note that

P=(tX,tY,d−t(d+l))

and the distance between P and the mirror GH is

σ={r+[t(d+l)−d] tan θ−tX} cos θ (33)

Hence, the reflection Q is of the following form

Q=P+2σNᵣ=C+t(P₁−C)+2σNᵣ (34)

where σ is defined in (33). We claim that Q defined by (29) is exactly the same as

the Q defined in (34). We need the following equation to prove this claim:

Δ+t(σ₁−Δ)=σ (35)

where Δ=r cos θ31 d sin θ and σ₁ and σ are defined in (31) and (33), respectively.

The proof of (35) follows:

$$\begin{matrix}Δ + t ( {σ}_{1} - Δ ) = r cos θ - d sin θ + t \{ ( h - X ) cos θ - r cos θ + d sin θ \} \\ = \{ r - d tan θ + t [ h - X - r + d tan θ ] \} cos θ \\ = \{ r - d tan θ - tX + t ( d + l ) tan θ \} cos θ \\ = \{ r + [ t ( d + l ) - d ] tan θ - tX \} cos θ \\ = σ\end{matrix}$$

But then since Vᵣ=C+2ΔNᵣ, we have

$$\begin{matrix}{L}_{1} ( t ) = {V}_{r} + t ( {Q}_{1} - {V}_{r} ) \\ = C + 2 Δ {N}_{r} + t ( {P}_{1} + 2 {σ}_{1} {N}_{r} - C - 2 Δ {N}_{r} ) \\ = C + t ( {P}_{1} - C ) + 2 ( Δ + t ( {σ}_{1} - Δ ) ) {N}_{r} \\ = P + 2 σ {N}_{r} \\ = Q\end{matrix}$$

Hence, the reflection of P=C+t(P₁−C) with respect to mirror GH is indeed Vᵣ+t(Q₁−Vᵣ) and this completes the proof of the theorem. Ξ

Representation (29) is an important observation. It shows to find the reflection of P₁P₂ about a particular mirror, one needs two things only: location of the virtual camera for that mirror and reflection of P₁ about that mirror. In the following, we list reflections of P₁P₂ about all mirrors.

(1) Reflection for the right mirror:

Q=Vᵣ+t(Q₁−Vᵣ)t ∈[1,t₂]
where Vᵣ=C+2ΔNᵣ and Q₁=P₁+2σₗNᵣ with Δ=r cos θ−d sin θ, σᵣ=(h−X)cos θ and Nᵣ=(cos θ,0, sin θ).

(2) Reflection for the left mirror:

Q=Vₗ+t(Q₁−Vₗ)t ∈[1,t₂]
where Vₗ=C+2ΔNₗ and Q₁=P₁+2σₗNₗ with Δ=r cos θ−d sin θ, σ₁=(h+X)cos θ and Nₗ=(−cos θ,0, sin θ).

(3) Reflection for the top mirror:

Q=Vₗ+t(Q₁−Vₜ)t ∈[1,t₂]
where Vₜ=C+2ΔNₜ and Q₁=P₁+2σₜNₜ with Δ=r cos θ−d sin θ, σₜ=(h−Y)cos θ and Nₜ=(0, cos θ, sin θ).

(4) Reflection of the bottom minor:

Q=V_{b}+t(Q₁−V_{b})t ∈[1,t₂]
where V_{b}=C+2ΔN_{b} and Q₁=P₁+2σ_{b}N_{b} with Δ=r cos θ−d sin θ, σ_{b}=(h+Y)cos θ and N_{b}=(0,−cos θ, sin θ).

Note that in the above cases,

$$X = ( x + \frac{1}{2} ) \frac{2 h}{m} - h and Y = ( y + \frac{1}{2} ) \frac{2 h}{n} - h .$$

We now show how to find P₁′ and P₂′ (or, P₁′ and P₃′), the projections of Q₁ and Q₂ (or, Q₁ and Q₃) on the virtual image plane with respect to the real camera C. This is basically a process of finding the matrix representation of a perspective projection.

Given a point (X,Y,Z), let (X′,Y′,Z′) be its projection on the virtual image plane with respect to the real camera C=(0,0,d). Recall that the virtual image plane is l units away from the origin of the coordinate system in the negative z direction. Hence, Z′=−l. Thus:

$$\frac{{Y}^{′}}{Y} = \frac{d + l}{d - Z} and \frac{{X}^{′}}{X} = \frac{d + l}{d - Z}$$

$$or$$

$${Y}^{′} = \frac{Y}{1 - ( Z + l ) / ( d + l )} and {X}^{′} = \frac{X}{1 - ( Z + l ) / ( d + l )}$$

Hence, we have

$$\begin{matrix}[ {X}^{′} , {Y}^{′} , {Z}^{′} , 1 ] = [ \frac{X}{1 - \frac{Z + l}{d + l}} , \frac{Y}{1 - \frac{Z + l}{d + l}} , - l , 1 ] \\ = [ 0 , 0 , d , 1 ] + [ \frac{X}{1 - \frac{Z + l}{d + l}} , \frac{Y}{1 - \frac{Z + l}{d + l}} , - d - l , - 1 ] \\ = [ 0 , 0 , d , 1 ] + [ X , Y , Z - d , \frac{d - Z}{d + l} ] \\ = [ \begin{matrix}1 & 0 & 0 & 0 \\ 0 & 1 & 0 & 0 \\ 0 & 0 & 1 & d \\ 0 & 0 & 0 & 1\end{matrix} ] [ \begin{matrix}1 & 0 & 0 & 0 \\ 0 & 1 & 0 & 0 \\ 0 & 0 & 1 & 0 \\ 0 & 0 & \frac{- 1}{d + l} & 0\end{matrix} ] [ \begin{matrix}X \\ Y \\ Z - d \\ 1\end{matrix} ] \\ = [ \begin{matrix}1 & 0 & 0 & 0 \\ 0 & 1 & 0 & 0 \\ 0 & 0 & 1 & 0 \\ 0 & 0 & 0 & 1\end{matrix} ] [ \begin{matrix}1 & 0 & 0 & 0 \\ 0 & 1 & 0 & 0 \\ 0 & 0 & 1 & 0 \\ 0 & 0 & \frac{- 1}{d + l} & 0\end{matrix} ] [ \begin{matrix}1 & 0 & 0 & 0 \\ 0 & 1 & 0 & 0 \\ 0 & 0 & 1 & - d \\ 0 & 0 & 0 & 1\end{matrix} ] [ \begin{matrix}X \\ Y \\ Z \\ 1\end{matrix} ] \\ = {M}_{l} ( 0 , 0 , d ) * {M}_{per} ( d + l ) * {M}_{l} ( 0 , 0 , - d ) [ \begin{matrix}X \\ Y \\ Z \\ 1\end{matrix} ]\end{matrix}$$

Consequently, matrix representation of the perspective projection is

$$\begin{matrix}M = {M}_{l} ( 0 , 0 , d ) * {M}_{per} ( d + l ) * {M}_{l} ( 0 , 0 , - d ) \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ]\end{matrix} \qquad ( 36 )$$

To get P₁′ and P₂′ (or, P₁′ and P₃′) for a particular view, simply multiply the corresponding Q₁ and Q₂ (or, Q₁ and Q₃) by the above matrix M.

(1) For the right view: to get P₁′, first compute the reflection of P₁ with respect to the right mirror:

$$\begin{matrix}{Q}_{1} = {P}_{1} + 2 {σ}_{r} {N}_{r} \\ = ( X , Y , - l ) + 2 {σ}_{r} ( cos θ , 0 , sin θ ) \\ = ( X + 2 {σ}_{r} cos θ , Y , - l + 2 σ , sin θ )\end{matrix}$$

where σᵣ=(h−X)cos θ. Then multiply the matrix representation of Q₁ by M:

$$\begin{matrix}{P}_{1}^{′} = {MQ}_{1} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}X + 2 {σ}_{r} cos θ \\ Y \\ - l + 2 {σ}_{r} sin θ \\ 1\end{matrix} ] \\ = [ \begin{matrix}X + 2 {σ}_{r} cos θ \\ Y \\ \frac{- l ( d + l - 2 {σ}_{r} sin θ )}{d + l} \\ \frac{d + l - 2 {σ}_{r} sin θ}{d + l}\end{matrix} ] \\ = [ \begin{matrix}\frac{( d + l ) ( X + 2 {σ}_{r} cos θ )}{d + l - 2 {σ}_{r} sin θ} \\ \frac{( d + l ) Y}{d + l - 2 {σ}_{r} sin θ} \\ - l \\ 1\end{matrix} ]\end{matrix}$$

To get P₂′, note that according to Theorem 2, the reflection of P₂ with respect to the right mirror can be computed as follows:

$$\begin{matrix}{Q}_{2} = {V}_{r} + {t}_{2} ( {Q}_{1} - {V}_{r} ) \\ = ( 2 Δcos θ , 0 , d + 2 Δsinθ ) + \\ {t}_{2} [ ( X + 2 {σ}_{r} cos θ , Y , - l + 2 {σ}_{r} sin θ ) - ( 2 Δcos θ , 0 , d + 2 Δsinθ ) ] \\ = ( \begin{matrix}2 Δcos θ + {t}_{2} ( X + 2 {σ}_{r} cos θ - 2 Δcos θ ) , {t}_{2} Y , d + \\ 2 Δsin θ + {t}_{2} ( - d - l + 2 {σ}_{r} sin θ - 2 Δsin θ )\end{matrix} )\end{matrix}$$

Since

$$\begin{matrix}X + 2 {σ}_{r} cos θ - 2 Δcos θ = X + 2 ( h - X ) {cos}^{2} θ - 2 ( \begin{matrix}r cos θ - \\ d sin θ\end{matrix} ) cos θ \\ = X ( 1 - 2 {cos}^{2} θ ) + 2 l sin θcos θ + 2 d sin θcosθ \\ = - X cos ( 2 θ ) + ( d + l ) sin ( 2 θ )\end{matrix}$$

$$and$$

$$\begin{matrix}d + l - 2 {σ}_{r} sin θ + 2 Δsin θ = d + l - 2 ( h - X ) cos θsin θ + \\ 2 ( r cos θ - d sin θ ) sin θ \\ = d ( 1 - 2 {sin}^{2} θ ) - 2 l {sin}^{2} θ + \\ l + 2 X cos θsin θ \\ = X sin ( 2 θ ) + ( d + l ) cos ( 2 θ )\end{matrix}$$

hence, we have

Q₂=(2Δ cos θ+t₂ρ₁ᵣ,t₂Y,d+2Δ sin θ+t₂ρ₂ᵣ)

where

ρ₁ᵣ=−X cos(2θ)+(d+l)sin(2θ)

ρ₂ᵣ=−X sin(2θ)−(d+l)cos(2θ) (37)

and t₂ is defined in (27). Now multiply the matrix representation of Q₂ by M to get P₂′:

$$\begin{matrix}{P}_{2}^{′} = {MQ}_{2} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}2 Δcos θ + {t}_{2} {ρ}_{1 r} \\ {t}_{2} Y \\ d + 2 Δsin θ + {t}_{2} {ρ}_{2 r} \\ 1\end{matrix} ] \\ = [ \begin{matrix}2 Δcos θ + {t}_{2} {ρ}_{1 r} \\ {t}_{2} Y \\ \frac{l ( d + 2 Δsin θ + {t}_{2} {ρ}_{2 r} ) - dl}{d + l} \\ \frac{- d - 2 Δsin θ - {t}_{2} {ρ}_{2 r} + d}{d + l}\end{matrix} ] \\ = [ \begin{matrix}\frac{( d + l ) ( 2 Δcos θ + {t}_{2} {ρ}_{1 r} )}{- 2 Δsin θ - {t}_{2} {ρ}_{2 r}} \\ \frac{( d + l ) {t}_{2} Y}{- 2 Δsin θ - {t}_{2} {ρ}_{2 r}} \\ - l \\ 1\end{matrix} ]\end{matrix}$$

where ρ₁ᵣ and ρ₂ᵣ defined in (37) and t₂ is defined in (27). This expression of P₂′ reduces to P₁′ when t₂=1. Hence it includes P₁′ as a special case.

The computation process of P₃′ for the right view is similar to the computation process of P₂′. First compute Q₃ as follows

Q₃=(2Δ cos θ+t₃ρ₁ᵣ,t₃Y,d+2Δ sin θ+t₃ρ₂ᵣ)

where ρ₁ᵣ and ρ₂ᵣ are defined as above, and t₃ is defined as previously. Then multiply [symbol] by the matrix M defined in (36). The result is similar to P₂′ (simply replace t₂ with t₃ in the expression of P₂′).

In the following, we show P₁′ and P₂′ for the left, the upper and the lower views. P₃′ will not be shown here because one can get P₃′ from P₂′ by replacing each t₂ in P₂′ with a t₃.

(2) For the left view: we have

Q₁=P₁+2σₗNₗ=(X−2σₗ cos θ,Y,−l+2σₗ sin θ)

where Nₗ=(−cos θ,0, sin θ) and σₗ=(h+X)cos θ. Hence

$$\begin{matrix}{P}_{1}^{′} = {MQ}_{1} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}X - 2 {σ}_{l} cos θ \\ Y \\ - l + 2 {σ}_{l} sin θ \\ 1\end{matrix} ] \\ = [ \begin{matrix}\frac{( d + l ) ( X - 2 {σ}_{l} cos θ )}{d + l - 2 {σ}_{l} sin θ} \\ \frac{( d + l ) Y}{d + l - 2 {σ}_{l} sin θ} \\ - l \\ 1\end{matrix} ]\end{matrix}$$

To get P₂′, we need to find Q₂ first. By Theorem 2, we have

$$\begin{matrix}{Q}_{2} = {V}_{l} + {t}_{2} ( {Q}_{1} - {V}_{l} ) \\ = ( - 2 Δcos θ , 0 , d + 2 Δsinθ ) + \\ {t}_{2} [ ( X - 2 {σ}_{l} cos θ , Y , - l + 2 {σ}_{l} sin θ ) - ( - 2 Δcos θ , 0 , d + 2 Δsinθ ) ] \\ = ( \begin{matrix}- 2 Δcos θ + {t}_{2} ( X - 2 {σ}_{l} cos θ + 2 Δcos θ ) , {t}_{2} Y , d + \\ 2 Δsin θ - {t}_{2} ( d + l - 2 {σ}_{l} sin θ + 2 Δsin θ )\end{matrix} )\end{matrix}$$

Since

$$\begin{matrix}X - 2 {σ}_{l} cos θ + 2 Δcos θ = X - 2 ( h + X ) {cos}^{2} θ + 2 ( \begin{matrix}r cos θ - \\ d sin θ\end{matrix} ) cos θ \\ = X ( 1 - 2 {cos}^{2} θ ) - 2 l sin θcos θ - 2 d sin θcosθ \\ = - X cos ( 2 θ ) - ( d + l ) sin ( 2 θ )\end{matrix}$$

$$and$$

$$\begin{matrix}d + l - 2 {σ}_{l} sin θ + 2 Δsin θ = d + l - 2 ( h + X ) cos θsin θ + \\ 2 ( r cos θ - d sin θ ) sin θ \\ = d ( 1 - 2 {sin}^{2} θ ) - 2 ( h - r ) cos θ sin θ + \\ l - 2 X cos θsin θ \\ = d cos ( 2 θ ) + l ( 1 - 2 {sin}^{2} θ ) - X sin ( 2 θ ) \\ = - X sin ( 2 θ ) + ( d + l ) cos ( 2 θ )\end{matrix}$$

Hence,

Q₂=(−2Δ cos θ+t₂ρ₁ₗ,t₂Y,d+2Δ sin θ+t₂ρ₂ₗ)

where

ρ₁ₗ=−X cos(2θ)−(d+l)sin(2θ)

ρ₂ₗ=X sin(2θ)−(d+l)cos(2θ) (38)

Therefore, we have

$$\begin{matrix}{P}_{2}^{′} = {MQ}_{2} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}- 2 Δ cos θ + {t}_{2} {ρ}_{1 l} \\ {t}_{2} Y \\ d + 2 Δ sin θ + {t}_{2} {ρ}_{2 l} \\ 1\end{matrix} ] \\ = [ \begin{matrix}\frac{( d + l ) ( - 2 Δ cos θ + {t}_{2} {ρ}_{1 l} )}{- 2 Δ sin θ - {t}_{2} {ρ}_{2 l}} \\ \frac{( d + l ) {t}_{2} Y}{- 2 Δ sin θ - {t}_{2} {ρ}_{2 l}} \\ - l \\ 1\end{matrix} ]\end{matrix}$$

where ρ₁ₗ and ρ₂ₗ are defined in (38) and t₂ is defined in (27).

(3) For the upper view: we have

$$\begin{matrix}{Q}_{1} = {P}_{1} + 2 {σ}_{t} {N}_{t} \\ = ( X , Y , - l ) + 2 {σ}_{t} ( 0 , cos θ , sin θ ) \\ = ( X , Y + 2 {σ}_{t} cos θ , - l + 2 {σ}_{t} sin θ )\end{matrix}$$

where σₗ=(h−Y)cos θ. Hence,

$$\begin{matrix}{P}_{1}^{′} = {MQ}_{1} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}X \\ Y + 2 {σ}_{t} cos θ \\ - l + 2 {σ}_{t} sin θ \\ 1\end{matrix} ] \\ = [ \begin{matrix}X \\ Y + 2 {σ}_{t} cos θ \\ \frac{l ( - l + 2 {σ}_{t} sin θ ) - dl}{d + l} \\ \frac{l - 2 {σ}_{t} sin θ + d}{d + l}\end{matrix} ] \\ = [ \begin{matrix}\frac{( d + l ) X}{d + l - 2 {σ}_{t} sin θ} \\ \frac{( d + l ) ( Y + 2 {σ}_{t} cos θ )}{d + l - 2 {σ}_{t} sin θ} \\ - l \\ 1\end{matrix} ]\end{matrix}$$

To get P₂′, we need to find Q₂ first. By Theorem 2, we have

$$\begin{matrix}{Q}_{2} = {V}_{t} + {t}_{2} ( {Q}_{1} - {V}_{t} ) \\ = ( 0 , 2 Δ cos θ , d + 2 Δ sin θ ) + \\ {t}_{2} [ \begin{matrix}( X , Y + 2 {σ}_{t} cos θ , - l + 2 {σ}_{t} sin θ ) - \\ ( 0 , 2 Δ cos θ , d + 2 Δ sin θ )\end{matrix} ] \\ = ( \begin{matrix}{t}_{2} X , 2 Δ cos θ + {t}_{2} ( Y + 2 {σ}_{t} cos θ - 2 Δ cos θ ) \\ d + 2 Δ sin θ + {t}_{2} ( - d - l + 2 {σ}_{t} sin θ - 2 Δ sin θ )\end{matrix} )\end{matrix}$$

Since

$$\begin{matrix}\begin{matrix}Y + 2 {σ}_{t} cos θ - 2 Δ cos θ = Y + 2 ( h - Y ) {cos}^{2} θ - 2 ( \begin{matrix}r cos θ - \\ d sin θ\end{matrix} ) cos θ \\ = Y ( 1 - 2 {cos}^{2} θ ) + 2 l sin θcos θ + 2 d sin θcos θ \\ = - Y cos ( 2 θ ) + ( d + l ) sin ( 2 θ )\end{matrix} \\ and \\ \begin{matrix}d + l - 2 {σ}_{t} sin θ + 2 Δ sin θ = d + l - 2 ( h - Y ) cos θsin θ + \\ 2 ( r cos θ - d sin θ ) sin θ \\ = d ( 1 - 2 {sin }^{2} θ ) - 2 l {sin}^{2} θ + 2 Y cos θsin θ \\ = ( d + l ) cos ( 2 θ ) + Y sin ( 2 θ )\end{matrix}\end{matrix}$$

Hence,

Q₂=(t₂X,2Δ cos θ+t₂ρ₁ᵣ,d+2Δ sin θ+t₂ρ₂ₗ)

where

ρ₁ₜ=−Y cos(2θ)+(d+l)sin(2θ)

ρ₂ₜ=−Y sin(2θ)−(d+l)cos(2θ) (39)

Therefore, we have

$$\begin{matrix}{P}_{2}^{′} = {MQ}_{2} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}{t}_{2} X \\ 2 Δ cos θ + {t}_{2} {ρ}_{1 t} \\ d + 2 Δ sin θ + {t}_{2} {ρ}_{2 t} \\ 1\end{matrix} ] \\ = [ \begin{matrix}{t}_{2} X \\ 2 Δ cos θ + {t}_{2} {ρ}_{1 t} \\ \frac{l ( d + 2 Δ sin θ + {t}_{2} {ρ}_{2 t} ) - dl}{d + l} \\ \frac{- d - 2 Δ sin θ - {t}_{2} {ρ}_{2 t} + d}{d + l}\end{matrix} ] \\ = [ \begin{matrix}\frac{( d + l ) {t}_{2} X}{- 2 Δ sin θ - {t}_{2} {ρ}_{2 t}} \\ \frac{( d + l ) ( 2 Δ cos θ + {t}_{2} {ρ}_{1 t} )}{- 2 Δ sin θ - {t}_{2} {ρ}_{2 t}} \\ - l \\ 1\end{matrix} ]\end{matrix}$$

where ρ₁ₜ and p₂ₜ are defined in (39) and t₂ is defined in (27).

(4) For the lower view: we have

$$\begin{matrix}{Q}_{1} = {P}_{1} + 2 {σ}_{b} {N}_{b} \\ = ( X , Y , - l ) + 2 {σ}_{b} ( 0 , - cos θ , sin θ ) \\ = ( X , Y - 2 {σ}_{b} cos θ , - l + 2 {σ}_{b} sin θ )\end{matrix}$$

where σ_{b}=(h+Y)cos θ. Hence,

$$\begin{matrix}{P}_{1}^{′} = {MQ}_{1} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + l} & \frac{d}{d + l}\end{matrix} ] [ \begin{matrix}X \\ Y - 2 {σ}_{b} cos θ \\ - l + 2 {σ}_{b} sin θ \\ 1\end{matrix} ] \\ = [ \begin{matrix}X \\ Y - 2 {σ}_{b} cos θ \\ \frac{l ( - l + 2 {σ}_{b} sin θ ) - dl}{d + l} \\ \frac{l - 2 {σ}_{b} sin θ + d}{d + l}\end{matrix} ] \\ = [ \begin{matrix}\frac{( d + l ) X}{d + l - 2 {σ}_{b} sin θ} \\ \frac{( d + l ) ( Y - 2 {σ}_{b} cos θ )}{d + l - 2 {σ}_{b} sin θ} \\ - l \\ 1\end{matrix} ]\end{matrix}$$

To get P₂′, we need to find Q₂ first. By Theorem 2, we have

$$\begin{matrix}{Q}_{2} = {V}_{b} + {t}_{2} ( {Q}_{1} - {V}_{b} ) \\ = ( 0 , - 2 Δ cos θ , d + 2 Δ sin θ ) + \\ {t}_{2} [ \begin{matrix}( X , Y + 2 {σ}_{b} cos θ , - l + 2 {σ}_{b} sin θ ) - \\ ( 0 , - 2 Δ cos θ , d + 2 Δ sin θ )\end{matrix} ] \\ = ( \begin{matrix}{t}_{2} X , - 2 Δ cos θ + {t}_{2} ( Y - 2 {σ}_{b} cos θ + 2 Δ cos θ ) , \\ d + 2 Δ sin θ + {t}_{2} ( - d - l + 2 {σ}_{b} sin θ - 2 Δ sin θ )\end{matrix} )\end{matrix}$$

Since

$$\begin{matrix}Y - 2 {σ}_{b} cos θ + 2 Δ sin θ = Y - 2 ( h + Y ) {cos}^{2} θ + 2 ( \begin{matrix}r cos θ - \\ d sin θ\end{matrix} ) cos θ \\ = - Y ( \begin{matrix}2 {cos}^{2} θ - \\ 1\end{matrix} ) - 2 l sin θcos θ - 2 d sin θcos θ \\ = - Y cos ( 2 θ ) - ( d + l ) sin ( 2 θ )\end{matrix}$$

$$and$$

$$\begin{matrix}- d - l + 2 {σ}_{b} sin θ - 2 Δ sin θ = - d - l + 2 ( h + Y ) cos θsin θ - \\ 2 ( r cos θ - d sin θ ) sin θ \\ = - d ( 1 - 2 {sin }^{2} θ ) + 2 l {sin}^{2} θ - l + \\ Y sin ( 2 θ ) \\ = Y sin ( 2 θ ) - ( d + l ) cos ( 2 θ )\end{matrix}$$

Hence,

Q₂=(t₂X,−2Δ cos θ+t₂ρ_{1b},d+2Δ sin θ+t₂ρ_{2b})

where

ρ_{1b}=−Y cos(2θ)−(d+l)sin(2θ)

ρ_{2b}=Y sin(2θ)−(d+l)cos(2θ) (40)

Therefore, we have

$$\begin{matrix}{P}_{2}^{′} = {MQ}_{2} \\ = [ \begin{matrix}1 & 0 & 0 & 0 \\ 0 & 1 & 0 & 0 \\ 0 & 0 & \frac{l}{d + l} & \frac{- dl}{d + l} \\ 0 & 0 & \frac{- 1}{d + L} & \frac{d}{d + l}\end{matrix} ] [ \begin{matrix}{t}_{2} X \\ - 2 Δ cos θ + {t}_{2} {ρ}_{1 b} \\ d + 2 Δ sin θ + {t}_{2} {ρ}_{2 b} \\ 1\end{matrix} ] \\ = [ \begin{matrix}{t}_{2} X \\ - 2 Δ cos θ + {t}_{2} {ρ}_{1 b} \\ \frac{l ( d + 2 Δ sin θ + {t}_{2} {ρ}_{2 b} ) - dl}{d + l} \\ \frac{- d - 2 Δ sin θ - {t}_{2} {ρ}_{2 b} + d}{d + l}\end{matrix} ] \\ = [ \begin{matrix}\frac{( d + l ) {t}_{2} X}{- 2 Δ sin θ - {t}_{2} {ρ}_{2 b}} \\ \frac{( d + l ) ( - 2 Δ cos θ + {t}_{2} {ρ}_{1 b} )}{- 2 Δ sin θ - {t}_{2} {ρ}_{2 b}} \\ - l \\ 1\end{matrix} ]\end{matrix}$$

where ρ_{1b} and ρ_{2b} are defined in (40) and t₂ is defined in (27).

Once we have P₁′ and P²′ (or, P₁′ and P₃′) in a particular virtual view of the virtual image plane, the next step was to find their counterparts in the STM image. We need their counterparts for the subsequent matching process to identify A's corresponding point A′. It is sufficient to show the process for a general point in the virtual right view.

Let P=(X,Y,−l) be an arbitrary point in the virtual right view of the virtual image plane. The lower-left, upper-left, lower-right and upper-right corners of the virtual right view are

D′=(h,−h,−l)

A′=(h,h,−l),

$${C}^{′} = ( \frac{r ( d + l )}{d} , \frac{- h ( d + l ) ( d + 2 Δ sin θ )}{d ( d + l + 2 Δ sin θ )} , - l ) , \\ and$$

$${B}^{′} = ( \frac{r ( d + l )}{d} , \frac{h ( d + l ) ( d + 2 Δ sin θ )}{d ( d + l + 2 Δ sin θ )} , - l ) ,$$

respectively, where d, r, l, h, and θ are parameters of the STMIS defined as before and Δ=r cos θ−d sin θ is the distance between the real camera and each of the mirror plane.

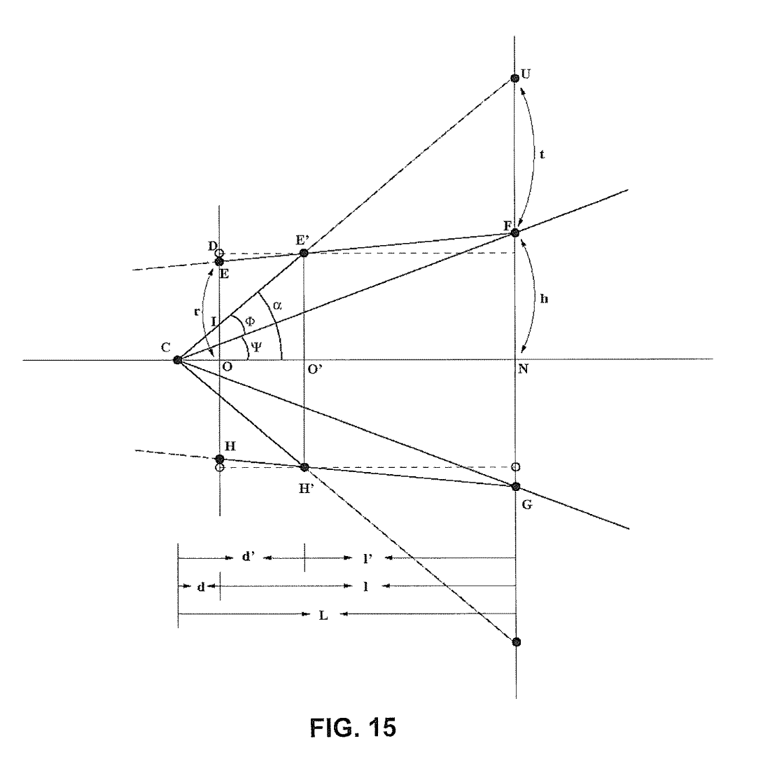

Let G=(x,y) be the counterpart of P in the right view of the STM image, x and y are real numbers (see FIG. 15). Here we assume a real number coordinate system has been imposed on the right view of the STM image, whose x- and y-axes coincide with the x- and y-axes of the original integer coordinate system of the right view. Therefore, it makes sense to consider points with real number coordinates in the right view of the STM image. The lower-left, upper-left, lower-right and upper-right corners of the right view of the STM image with this real number coordinate system are now:

$$D = ( - \frac{1}{2} , - \frac{1}{2} ) , \\ A = ( - \frac{1}{2} , n - \frac{1}{2} ) , \\ C = ( {m}_{1} - \frac{1}{2} , - q - \frac{1}{2} )$$

$$and$$

$$B = ( {m}_{1} - \frac{1}{2} , n + q - \frac{1}{2} ) ,$$

respectively, where mₗ>0 is the resolution of the right view in x direction and n+2q (q>0) is the resolution of the right view's right edge BC.

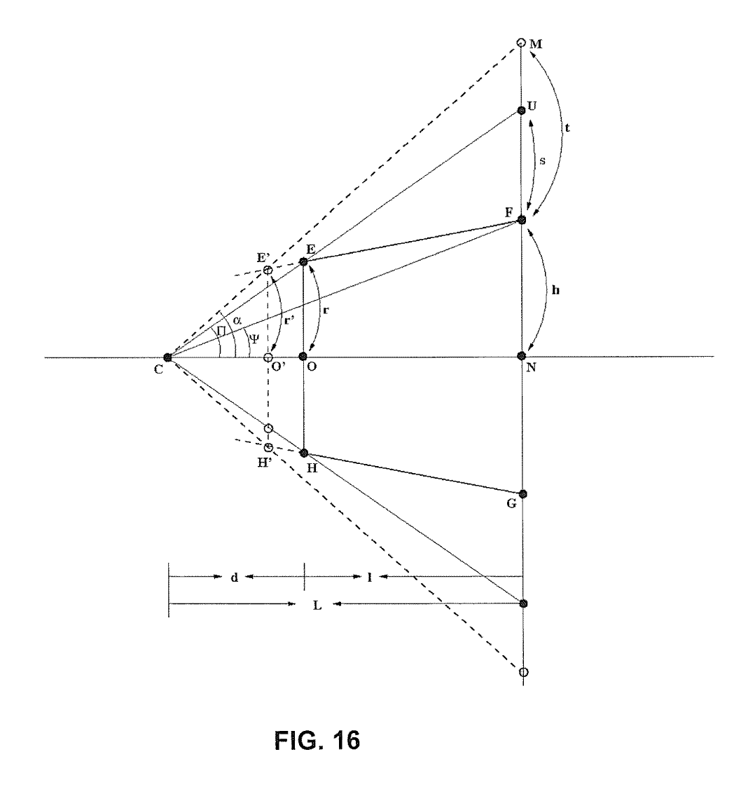

The x- and y-coordinates of G can be computed as follows. Note that the shape of the virtual right view and the shape of the right view of the STM image are similar. This implies that the shape of the rectangle A′E′F′D′ is also similar to the shape of the rectangle AEFD (see FIG. 16). Therefore, when we use ‘aspect ratio preserving property’ to compute x and y, we can simply consider aspect rations of P in the rectangle A′E′F′D′ and aspect ratios of G in the rectangle AEFD. By using the aspect ration preserving property in the x direction, we have

$$\frac{X - h}{x - ( - 1 / 2 )} = \frac{r ( d + l ) / d - h}{{m}_{1} - 1 / 2 - ( - 1 / 2 )} , \\ or \\ \frac{X - h}{x + 1 / 2} = \frac{r ( d + l ) / d - h}{{m}_{1}} = \frac{r ( d + l ) / d - h}{( r ( d + l ) / d - h ) ( m / 2 h )} , \\ or \frac{X - h}{x + 1 / 2} = \frac{2 h}{m} , \\ or \\ x + \frac{1}{2} = \frac{m ( X - h )}{2 h} , \\ or x = - \frac{1}{2} + \frac{m ( X - h )}{2 h} = \frac{- h + m ( X - h )}{2 h} . \\ Hence , x = \frac{mX - ( m + 1 ) h}{2 h} . \qquad ( 41 )$$

By using the aspect ration preserving property in the y direction in the rectangle A′E′F′D′ and in the rectangle AEFD we have

$$\frac{y + 1 / 2}{Y + h} = \frac{n - 1 / 2 - ( - 1 / 2 )}{h - ( - h )} = \frac{n}{2 h} , \\ or \\ y + \frac{1}{2} = \frac{nY + nh}{2 h} , \\ or y = - \frac{1}{2} + \frac{nY + nh}{2 h} = \frac{nY + nh - h}{2 h} . \\ Hence , y = \frac{nY + ( n - 1 ) h}{2 h} . \qquad ( 42 )$$

The computation of counterparts for other virtual views can be done similarly. The results are listed below.

Let P=(X,Y,−l) be an arbitrary point in the virtual left view of a virtual image plane (see FIG. 16) whose lower-left, upper-left, lower-right and upper-right corners are

$${C}^{′} = ( \frac{- r ( d + l )}{d} , \frac{- h ( d + l ) ( d + 2 Δsin θ )}{d ( d + l + 2 Δsinθ )} , - l ) , \\ {B}^{′} = ( \frac{- r ( d + l )}{d} , \frac{h ( d + l ) ( d + 2 Δsin θ )}{d ( d + l + 2 Δsinθ )} , - l ) , \\ {D}^{′} = ( - h , - h , - l ) and$$

$${A}^{′} = ( - h , h , - l ) ,$$

respectively. If G=(x,y) is the counterpart of P in the left view of the STM image whose lower-left, upper-left, lower-right and upper-right corners are

C=(−m₁+½,−q−½),

B=(−m₁+½,n+q−½),

D=(½,−½) and

A=(½,n−½),

respectively, then x and y are real numbers of the following values

$$\begin{matrix}x = \frac{mX + ( m + 1 ) h}{2 h} & ( 43 ) \\ y = \frac{nY + ( n - 1 ) h}{2 h} & ( 44 )\end{matrix}$$

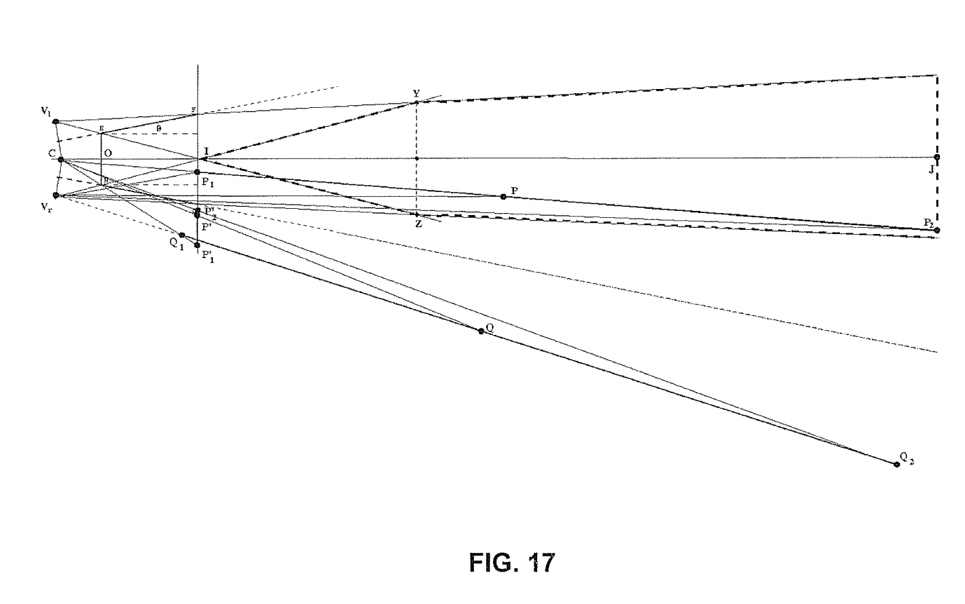

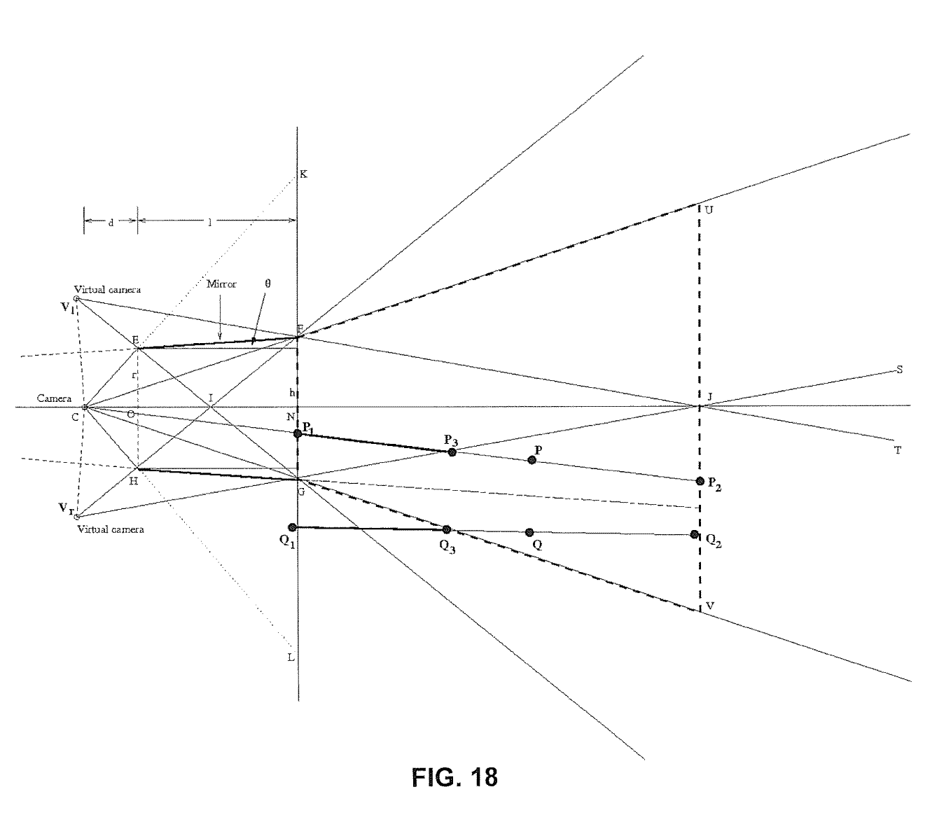

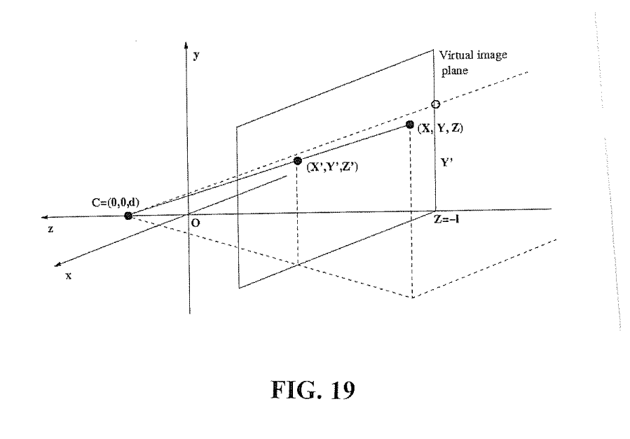

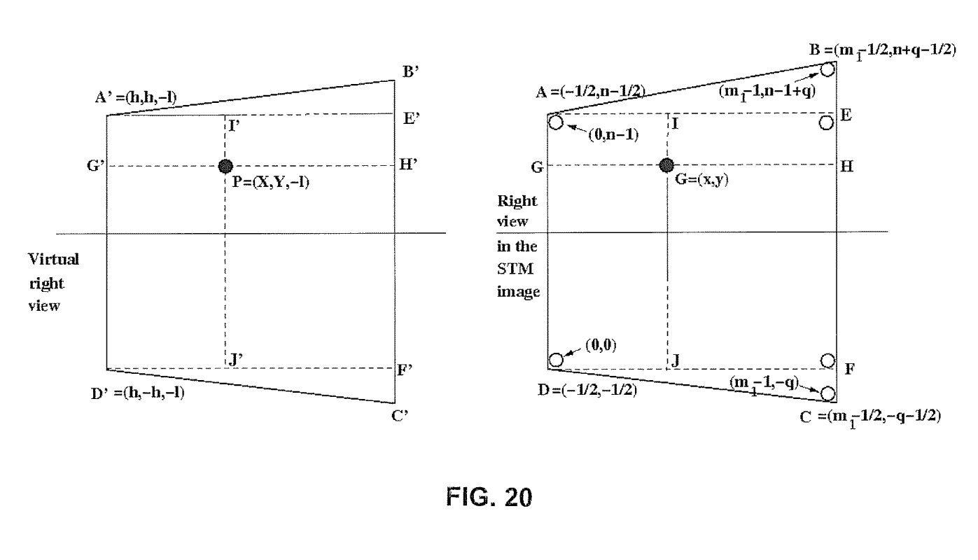

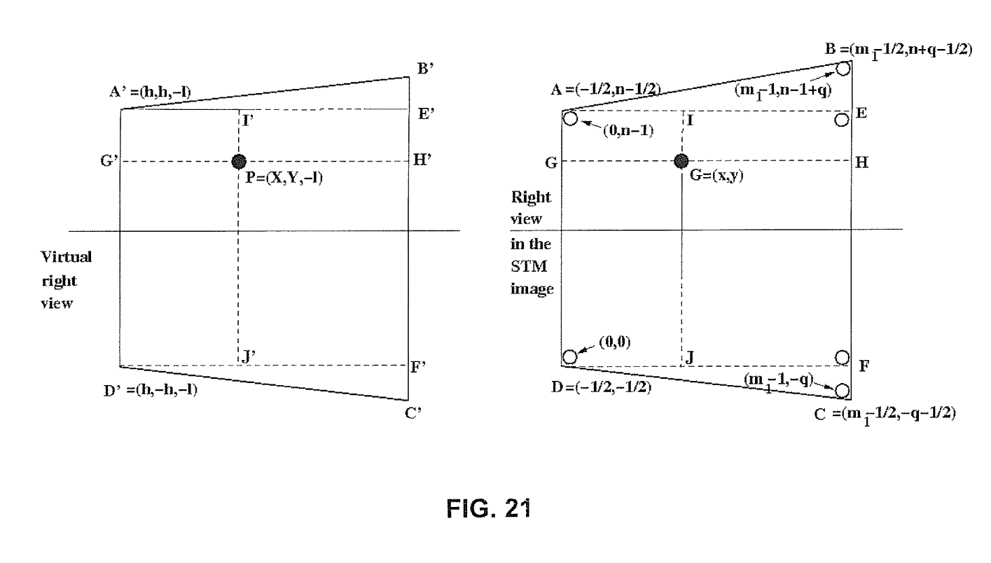

Let P=(X,Y,−l) be an arbitrary point in the virtual upper view of a virtual image plane (see FIG. 17) whose lower-left, upper-left, lower-right and upper-right corners are

$${D}^{′} = ( - h , h , - l ) , \\ {C}^{′} = ( \frac{- h ( d + l ) ( d + 2 Δsin θ )}{d ( d + l + 2 Δsin θ )} , \frac{r ( d + l )}{d} , - l ) , \\ {B}^{′} = ( \frac{h ( d + l ) ( d + 2 Δsin θ )}{d ( d + l + 2 Δsin θ )} , \frac{r ( d + l )}{d} , - l ) and$$

$${A}^{′} = ( h , h - l ) ,$$

respectively. If G=(x,y) is the counterpart of P in the upper view of the STM image whose lower-left, upper-left, lower-right and upper-right corners are

D=(−½,−½),

C=(−p−½,n₁−½),

B=(m−½+p,n₁−½) and

A=(m−½,−½),

respectively, then x and y are real numbers of the following values

$$\begin{matrix}x = \frac{mX + ( m - 1 ) h}{2 h} & ( 45 ) \\ y = \frac{nY - ( n + 1 ) h}{2 h} & ( 46 )\end{matrix}$$

For the lower view case, we will simply give the x- and y-coordinates of the counterpart G=(x,y) in the lower view of the STM image for the given point P=(X,Y,−l) in the virtual lower view of the virtual image plane:

$$\begin{matrix}x = \frac{mX + ( m - 1 ) h}{2 h} & ( 47 ) \\ y = \frac{nY + ( n + 1 ) h}{2 n} & ( 48 )\end{matrix}$$

With the computation processes developed above, we are ready for initial screening of the corresponding points now. The concept is described as follows.

For each point A=(x,y), 0≦x≦m−1, 0≦y≦n−1, in the central view of the given STM image where in x n is the resolution of the central view, first identify its corresponding point P₁=(X,Y,−l) in the virtual central view of the virtual image plane with

$$X = ( x - \frac{m}{2} ) \frac{2 h}{m} + \frac{h}{m} = ( x + \frac{1}{2} ) \frac{2 h}{m} - h$$

$$Y = ( y - \frac{n}{2} ) \frac{2 h}{n} + \frac{h}{n} = ( y + \frac{1}{2} ) \frac{2 h}{n} - h$$

where l is the length of the STM and 2h×2h is the dimension of the front opening of the STM.

We then compute the location of the point P₂ by using (27) to compute the values of t₂ first and then using the following equation to get coordinates of P₂:

P₂=C+t₂(P₁−C)=(t₂X,t₂Y,d−t₂(d+l))

where C=(0,0,d) is the location of the pinhole of the camera. The value of d can be determined using the technique described previously.

Note that if the following condition is satisfied:
(i) 2Δ cos θ>h and X≠0, or
(ii) 2Δ cos θ<h and |X|> X̅ where

$$\overline{X} = \frac{( d + l ) ( d + l + 2 Δsin θ ) ( {Δ}_{1} - {Δ}_{2} ) [ ( λ - 1 ) {Δ}_{1} - {Δ}_{2} ]}{( d + r tan θ ) ( {Δ}_{1} + {Δ}_{2} ) - λ ( d + 2 Δsin θ ) ( {Δ}_{1} - {Δ}_{2} )} ,$$

Δ=r cos θ−d sin θ, Δ₁ and Δ₂ are defined above, 2r×2r is the dimension of the rear end of the STM and λ is a constant between 2 and 4 specified by the user for the location of the general J-point (see (26) for the definition of the general J-point), then t₂ should be computed using (27).

Next, we compute the projections of P₁ and P₂ in the virtual right view, virtual left view, virtual upper view and virtual lower view. These projections will be called P₁ᵣ′ and P₂ᵣ′, P₁ₗ′ and P₂ₗ′, P₁ᵣ′ and P₂ᵣ′and P_{1b}′ and P_{2b}′, respectively. They are listed below:

$${P}_{1 r}^{′} = ( \frac{( d + l ) ( X + 2 σ , cos θ )}{d + l - 2 {σ}_{r} sin θ} , \frac{( d + l ) Y}{d + l - 2 {σ}_{r} sin θ} , - l )$$

$${P}_{2 r}^{′} = ( \frac{( d + l ) ( 2 Δcos θ + {t}_{2} {ρ}_{1 r} )}{- 2 Δsin θ - {t}_{2} {ρ}_{2 r}} , \frac{( d + l ) {t}_{2} Y}{- 2 Δsin θ - {t}_{2} {ρ}_{2 r}} , - l )$$

$${P}_{1 l}^{′} = ( \frac{( d + l ) ( X - 2 {σ}_{l} cos θ )}{d + l - 2 {σ}_{l} sin θ} , \frac{( d + l ) Y}{d + l - 2 {σ}_{l} sin θ} , - l )$$

$${P}_{2 l}^{′} = ( \frac{( d + l ) ( - 2 Δcos θ + {t}_{2} {ρ}_{1 l} )}{- 2 Δsin θ - {t}_{2} {ρ}_{2 l}} , \frac{( d + l ) {t}_{2} Y}{- 2 Δsin θ - {t}_{2} {ρ}_{2 l}} , - l )$$

$${P}_{1 i}^{′} = ( \frac{( d + l ) X}{d + l - 2 {σ}_{i} sin θ} , \frac{( d + l ) ( Y + 2 {σ}_{i} cos θ )}{d + l - 2 {σ}_{i} sin θ} , - l )$$

$${P}_{2 i}^{′} = ( \frac{( d + l ) {t}_{2} X}{- 2 Δsin θ - {t}_{2} {ρ}_{2 i}} , \frac{( d + l ) ( 2 Δcosθ + {t}_{2} {ρ}_{1 i} )}{- 2 Δsin θ - {t}_{2} {ρ}_{2 i}} , - l )$$

$${P}_{1 b}^{′} = ( \frac{( d + l ) X}{d + l - 2 {σ}_{b} sin θ} , \frac{( d + l ) ( Y - 2 {σ}_{b} cos θ )}{d + l - 2 {σ}_{b} sin θ} , - l )$$

$${P}_{2 b}^{′} = ( \frac{( d + l ) {t}_{2} X}{- 2 Δsin θ - {t}_{2} {ρ}_{2 b}} , \frac{( d + l ) ( - 2 Δcos θ + {t}_{2} {ρ}_{1 b} )}{- 2 Δsin θ - {t}_{2} {ρ}_{2 b}} , - l )$$

where

σᵣ=(h−X)cos θ;

σₗ=(h+X)cos θ;

σᵢ=(h−Y)cos θ;

σ_{b}=(h+Y)cos θ;

and ρᵢᵥ, ρᵢₗ, ρᵢᵣ and ρ_{ib}, i=1,2, are defined as set forth above.

We then set a step size for the digitization parameter t of the line segment P₁P₂ as follows:

Δₜ=δ/(d+l)

where

δ=min{2h/m,2h/n}

This step size will ensure that each digitized element of P₁P₂ is of length δ, the minimum of the dimension

$$\frac{2 h}{m} \times \frac{2 h}{n}$$

of a virtual pixel in the virtual image plane. The digitization process starts at P₁(t=1) and proceeds by the step size

Δ_{P}=Δₗ(P₁−C).

The number of digitized elements of the line segment P₁P₂ is

$$N = [ \frac{{t}_{2} - 1}{{Δ}_{t}} ] .$$

The basic idea of the searching process for corresponding points in the right view can be described as follows. The searching process for corresponding points in the other views is similar.

For the i-th digitized element P of P₁P₂

P=C+(1+iΔₜ)(P₁−C)=P₁+iΔₚ

we find its projection P′ in the virtual right view

$${P}^{′} = ( \overline{X} , \overline{Y} , - l ) = ( \begin{matrix}\frac{( d + l ) ( \begin{matrix}2 Δcosθ + \\ ( 1 + i Δ t ) {ρ}_{1 r}\end{matrix} )}{- 2 Δsin θ - ( 1 + i {Δ}_{i} ) {ρ}_{2 r}} , \\ \frac{( d + l ) ( 1 + i {Δ}_{i} ) Y}{- 2 Δsinθ - ( 1 + i {Δ}_{i} ) {ρ}_{2 r}} , - l\end{matrix} )$$

and the counterpart of P′ in the STM image's right view

$$G = ( α , β ) = ( \frac{m \overline{X} - ( m + 1 ) h}{2 h} , \frac{n \overline{Y} + ( n - 1 ) h}{2 h} ) .$$

A matching process is then performed on a patch centered at A=(α,β) in the STM image's central view and a patch centered at G=(α,β) in the STM image's right view. This matching process will return the difference of the intensity values of the patches. Whichever P′ whose returned difference result is the smallest and is smaller than a given tolerance is considered the corresponding point of P₁ (or, A=(x,y)).

In the above process, P can be computed using an incremental method. Actually P′ can be computed using an incremental method as well. Note that the start point of P is P₁ and the start point of P′ is P₁′. Hence, it is sufficient to show that the second point of P′ (t=1+Δₗ) can be computed from P₁′ incrementally. First, note that

$$\begin{matrix}2 Δcos θ + {ρ}_{1 r} = 2 ( r cos θ - d sin θ ) cos θ - X cos ( 2 θ ) + ( d + l ) sin ( 2 θ ) \\ = 2 r {cos}^{2} θ - 2 d cos θsin θ - X {cos}^{2} θ + \\ X {sin}^{2} θ + 2 ( d + l ) cos θsin θ \\ = 2 ( r + l tan θ ) {cos}^{2} θ - 2 X {cos}^{2} θ + X \\ = X + 2 h {cos}^{2} θ - 2 X {cos}^{2} θ \\ = X + 2 [ ( h - X ) cos θ ] cos θ \\ = X + 2 {σ}_{r} cos θ\end{matrix}$$

$$and$$

$$\begin{matrix}- 2 Δsinθ - {ρ}_{2 r} = - 2 ( r cos θ - d sin θ ) sin θ + X sin ( 2 θ ) + ( d + l ) cos ( 2 θ ) \\ = - 2 r cos θsin θ + 2 d {sin}^{2} θ + 2 X cos θsinθ + \\ ( d + l ) ( {cos}^{2} θ - {sin}^{2} θ ) \\ = d + l - 2 r cos θsin θ - 2 l {sin}^{2} θ + 2 X cos θsin θ \\ = d + l - 2 ( r + l tan θ ) cos θsin θ + 2 X cos θsin θ \\ = d + l - 2 h cos θsin θ + 2 X cos θsin θ \\ = d + l - 2 {σ}_{r} sin θ .\end{matrix}$$

The second point of P′ (t=1+Δₜ) can be expressed as

$$\begin{matrix}{P}^{′} = ( \frac{( d + l ) ( 2 Δcos θ + ( 1 + {Δ}_{i} ) {ρ}_{1 r} )}{- 2 Δsin θ - ( 1 + {Δ}_{i} ) {ρ}_{2 r}} , \frac{( d + l ) ( 1 + {Δ}_{i} ) Y}{- 2 Δsin θ - ( 1 + {Δ}_{i} ) {ρ}_{2 r}} , - l ) \\ = ( \frac{( d + l ) ( 2 Δcos θ + {ρ}_{1 r} + {Δ}_{i} {ρ}_{1 r} )}{- 2 Δsin θ - {ρ}_{2 r} - {Δ}_{i} {ρ}_{2 r}} , \frac{( d + l ) Y + {Δ}_{i} ( d + l ) Y}{- 2 Δsin θ - {ρ}_{2 r} - {Δ}_{i} {ρ}_{2 r}} , - l ) \\ = ( \begin{matrix}\frac{( d + l ) ( X + 2 {σ}_{r} cos θ ) + {Δ}_{i} ( d + l ) {ρ}_{1 r}}{d + l - 2 {σ}_{r} sin θ - {Δ}_{i} {ρ}_{2 r}} , \\ \frac{( d + l ) Y + {Δ}_{i} ( d + l ) Y}{d + l - 2 {σ}_{r} sin θ - {Δ}_{i} {ρ}_{2 r}} , - l\end{matrix} )\end{matrix}$$

Hence, if we define

A=(d+l)(X+2σ, cos θ);

B=d+l−2σᵣ sin θ;

E=(d+l)Y;

and

Δ_{A}=Δₜ(d+l)ρ₁ᵣ;

Δ_{B}=Δₜρ₂ᵣ;

Δ_{E}=Δₗ(d+l)Y

then P′ for t=1+Δₗ can be written as

$${P}^{′} = ( \frac{A + {Δ}_{A}}{B - {Δ}_{B}} , \frac{E + {Δ}_{E}}{B - {Δ}_{B}} , - l )$$

Note that A/B is the x-coordinate of P¹′ and E/B is the y-coordinate of P₂′. Hence P′ can indeed be computed incrementally.

The skilled artisan will appreciate that the above calculations may be embodied in software code for converting an STM image as described herein into an image-plus-depth, and from there to a 3D image. Example software code is set forth herein in Appendices 1 and 2.

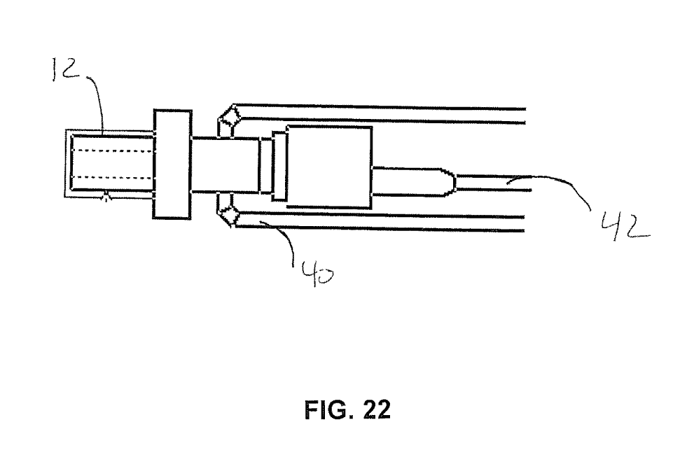

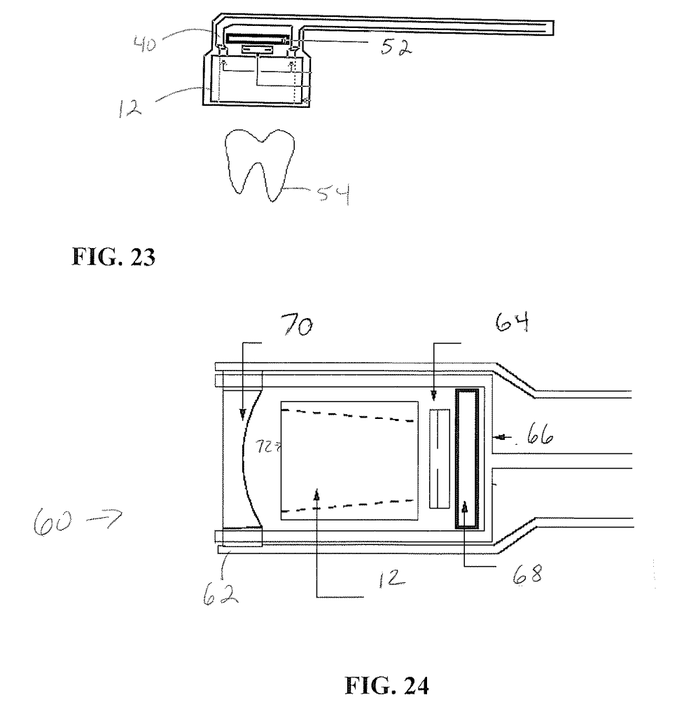

The skilled artisan will further appreciate that the above-described devices, and methods and software therefore, are adaptable to a variety of applications, including document cameras, endoscopy, three-dimensional Web cameras, and the like. Representative designs for devices for providing three-dimensional intraoral images are shown in FIGS. 22 and 23, having an STM 12 according to the present disclosure, an external structured light source 40, and an imager (digital camera 42 in FIG. 22, shutter/CCD 52 in FIG. 23. The device of FIG. 22 is contemplated for obtaining three-dimensional images of an entirety of a patient's oral cavity, whereas the device of FIG. 23 is contemplated for obtaining three-dimensional images of discrete regions of a patient's oral cavity, such as tooth 54.

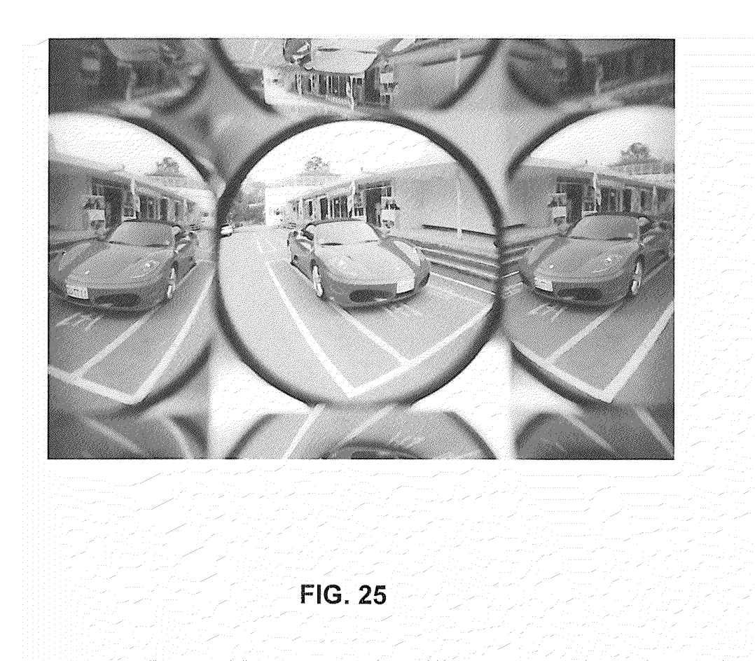

Likewise, FIG. 24 shows an embodiment of a three-dimensional Web camera 60, comprising an STM 12 according to the present disclosure. The camera 60 includes a housing 62, a lens/aperture 64, an external light source 66, and a shutter/CCD 68. A concave lens 70 is provided at a front opening 72 of the STM 12 to reduce the size of the Web camera 60 without reducing the necessary field of view. FIG. 25 presents a nine-view image provided by a three-dimensional Web camera as shown in FIG. 24, demonstrating that the field of view for the STM of the present disclosure is indeed larger.

The foregoing description is presented for purposes of illustration and description of the various aspects of the invention. One of ordinary skill in the art will recognize that additional embodiments of the invention are possible without departing from the teachings herein. This detailed description, and particularly the specific details of the exemplary embodiments, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures. All such modifications and variations are within the scope of the to invention as determined by the appended claims when interpreted in accordance with the breadth to which they are fairly, legally and equitably entitled.

### APPENDIX 1

[Computing Corresponding Point Pᵣ′]
[Initialization]
σᵣ := (h − X)cosθ;

| ρ₁ᵣ := −X cos(2θ) + (d + l)sin(2θ); | |
|---|---|
| ρ₂ᵣ := −X sin(2θ) − (d + l)cos(2θ); | |
| C := (0,0,d); /* Location of the camera */ | |
| P₁ = (X,Y,−l); /* Corresponding point of A in virtual central view */ | |
| t := 1; /* Start point of the digitization parameter of P₁P₂ */ | |
| Δₜ := δ/(d + l); /* Step size for digitization parameter of P₁P₂ */ | |
| P := P₁; /* Start point of the digitization */ | |
| Δ_{P} := Δₜ (P₁ − C); /* Step size for digitization of P₁P₂ */ | |
| tₘᵢₙ := 1; /* Initialize the parameter for Pᵣ′ */ | |
| Pₘᵢₙ := P₁; /* Initialize the location of Pᵣ′ */ | |
| A := (X + 2σᵣ cosθ)(d + l); /* Numerator of x-component of P₁′ */ | |
| B := d + l − 2σᵣ sinθ; /* Denominator of x-component of P₁′ */ | |
| E := (d + l)Y; | /* Numerator of y-component of P₁′ */ |

| | |
|---|---|
| Δ := Δₜρ₁ᵣ (d + l); | /* Step size for updating A */ |
| Δ_{B} := Δₜρ₂ᵣ; | /* Step size for updating B */ |
| Δ_{E} := ΔE; | /* Step size for updating E */ |

εₜ := 1; /* Initialize the error tolerance for intensity comparison */

[Corresponding Point Identification]

for i := 1 to N − 1 do {

t := t + Δₜ; /* Update the digitization parameter */
P := P + Δ_{P}; /* Update current location of digitization process */
A := A + Δ_{A}; /* Update numerator of x-component of P′ */
B := B − Δ_{B}; /* Update denominator of x-component of P′ */
E := E + Δ_{E}; /* Update numerator of y-component of P′ */
X̅ := A/B; /* Compute x-component of P′ */
Y̅ := E/B; /* Compute y-component of P′ */
α := [m X̅ − (m + 1)h]/(2h);
β := [n Y̅ + (n − 1)h]/(2h);
/* (α,β) is the counterpart of P′ in the STM image's right
view */
ε := Match(x,y,α,β);
if (ε < εᵣ) then {εᵣ := ε; tₘᵢₙ := t; Pₘᵢₙ := P;}
/* this step keeps track of the digitized element whose projection
in the */

/* virtual right view has the smallest difference on intensity value
with */
/* that of A = (x,y) in the central view */
}
Depth_of_A := (Pₘᵢₙ)_{z};

In the above code, Match(x,y,α,β) is a function that will compare intensities of a patch centered at (x,y) in the central view with the intensities of a same dimension patch centered at (α,β) in the right view of the STM image. match( ) can use one of the techniques described in herein or a technique of its own. This function returns a positive real number as the difference of the intensity values.

Note also that the parameters α and β are real numbers, not integers. When computing the intensity at (α,β), one shouldn't simply round α and β to the nearest integers, but use the following formula instead to get a more appropriate approximation:

I(α,β)=C_{i,j}I(i,j)+C_{i+1,j}I(i+1,j)+C_{i,j+1}I(i+1,j)+C_{i+1 j+1}I(i+1,j+1)

where i≦α<i+1, j≦β<j+1 and C_{i,j}, C_{i+1,j}, C_{i,j+1} and C_{i+1,j+1} are real number coefficients defined as follows:

C_{i,j}=(i+1−α)(j+1−β);

C_{i+1,j}=(α−i)(j+1−β);

C_{i,j+1}=(i+1−α)(β−j);

C_{i+1,j+1}=(α−i)(β−j).

### APPENDIX 2

One can easily extend the software code of Appendix 1 to compute Pᵣ′, Pₗ′, Pₜ′ and P_{b}′ at the same time. The code is shown below.

[Computing Corresponding Points Pᵣ′, Pₗ′, Pₜ′ and P_{b}′]
[Initialization]
σᵣ := (h − X)cosθ; σₗ := (h + X)cosθ;
σₜ := (h − Y)cosθ; σ_{b} := (h + Y)cosθ;

| ρ₁ᵣ := −X cos(2θ) + (d + l)sin(2θ); | |
|---|---|
| ρ₂ᵣ := −X sin(2θ) − (d + l)cos(2θ): | |
| ρ₁ₗ := −X cos(2θ) − (d + l)sin(2θ); | |
| ρ₂ₗ := X sin(2θ) − (d + l)cos(2θ); | |
| ρ₁ₜ := −Y cos(2θ) + (d + l)sin(2θ); | |
| ρ₂ₜ −Y sin(2θ) − (d + l)cos(2θ); | |
| ρ_{1b} := −Y cos(2θ) − (d + l)sin(2θ); | |
| ρ_{2b} := Y sin(2θ) − (d + l)cos(2θ); | |
| C := (0,0,d); /* Location of the camera */ | |
| P₁ = (X,Y,−l); /* Corresponding point of A in virtual central view */ | |
| t := 1; | /* Start point of the digitization parameter of P₁P₂ */ |

Δ₁ := δ/(d + l); /* Step size for digitization parameter of P₁P₂ */
P := P₁; /* Start point of the digitization */
Δ_{P} := Δₜ(P₁ − C); /* Step size for digitization of P₁P₂ */
t_{min.r} := 1; P_{min.r} := P₁; t_{min.l} := 1; P_{min.l} := P₁;
/* Initialize the tracking parameters and pointers for Pᵣ′ and Pₗ′ */
t_{min.t} := 1; P_{min.t} := P₁; t_{min.b} := 1; P_{min.b} := P₁;

/* Initialize the tracking parameters and pointers for Pₜ′ and P_{b}′*/

t_{min.rl} := 1; P_{min.rl} := P₁; t_{min.tb} := 1; P_{min.tb} := P₁;
/* Initialize the tracking parameters and pointers for cross-matching on */

/* Pᵣ′ and Pₗ′, and on Pₜ′ and P_{b}′*/

t_{min.rt} := 1; P_{min.rt} := P₁; t_{min.lb} := 1; P_{min.lb} := P₁;
/* Initialize the tracking parameters and pointers for cross-matching on */

/* Pᵣ′ and Pₜ′, and on Pₗ′ and P_{b}′*/

t_{min.lt} := 1; P_{min.lt} := P₁; t_{min.rb} := 1; P_{min.rb} := P₁;
/* Initialize the tracking parameters and pointers for cross-matching on */

/* Pₗ′ and Pₜ′, and on Pᵣ′ and P_{b}′*/
AR := (X + 2σᵣ cosθ)(d + l); /* Numerator of x-component of P₁′ in RV*/

| BR := d + l − 2σᵣ sinθ; /* Denominator of x-component of P₁′ in RV*/ | |
|---|---|
| ER := (d + l)Y; | /* Numerator of y-component of P₁′ in RV*/ |

AL := (X − 2σₗ cosθ)(d + l); /* Numerator of x-component of P′₁ in LV*/

BL := d + l − 2σ sinθ; /* Denominator of x-component of P₁′ in LV*/

AT := (Y + 2σₜ cosθ)(d + l); /* Numerator of y-component of P₁′ in UV*/

| BT := d + l − 2σₜ sinθ; /* Denominator of y-component of P₁′ in UV*/ | |
|---|---|
| ET := (d + l)X; | /* Numerator of x-component of P₁′ in UV*/ |

AB := (Y − 2σ_{b} cosθ)(d + l); /* Numerator of x-component of P₁′ in BV*/

| BB := d + l − 2σ_{b} sinθ; /* Denominator of x-component of P₁′ in BV*/ | |
|---|---|
| Δ_{AR} := Δₜ(d + l)ρ₁ᵣ; | /* Step size for updating AR*/ |
| Δ_{BR} := Δₜρ₂ₜ; | /* Step size for updating BR */ |
| Δ_{ER} := Δₜ(d + l)Y; | /* Step size for updating ER */ |
| Δ_{AL} := Δₜ(d + l)ρ₁ₗ; | /* Step size for updating AL*/ |
| Δ_{BL} := Δₜρ₂ₗ; | /* Step size for updating BL */ |
| Δ_{AT} := Δₜ(d + l)ρₗₜ; | /* Step size for updating AT*/ |
| Δ_{BT}. := Δρ₂ₜ; | /* Step size for updating BT */ |
| Δ_{ET} := Δₜ(d + l)X; | /* Step size for updating ET */ |

| | |
|---|---|
| Δ_{AB} := Δₜ(d + l}ρ_{1b}; | /* Step size for updating AB*/ |

| | |
|---|---|
| Δ_{BB} := Δₜρ_{2b}; | /* Step size for updating BB */ |

| | | | |
|---|---|---|---|
| εᵣ := 1; | εₗ := 1; | εₜ := 1; | ε_{b} := 1; |
| εᵣₗ := 1 | ε_{tb} := 1; | εᵣₜ := 1; | ε_{rb} := 1; |

| | |
|---|---|
| εₗₜ := 1; | ε_{lb} := 1; |

/* Initialize the error tolerances for intensity comparison */

[Corresponding Point Identification]

for i := 1 to N − 1 do {

| t := t + Δₜ; /* Update the digitization parameter */ | |
|---|---|
| P := P + Δ_{P}; /* Update corrent location of digitization process */ | |
| AR := AR + Δ_{AR}; | AL := AL + Δ_{AL}; |

/* Update numerator of x-component of P′ in RV and LV*/

| | |
|---|---|
| BR := BR + Δ_{BR}; | BL := BL + Δ_{BL}; |

/* Update denominator of x-component of P′ in RV and LV*/

ER := ER + Δ_{ER};

/* Update numerator of y-component of P′ in RV and LV */

| | |
|---|---|
| AT := AT + Δ_{AT}; | AB := AB + Δ_{AB}; |

/* Update numerator of y-component of P′ in TV and BV*/

| | |
|---|---|
| BT := BT + Δ_{BT}; | BB := BB + Δ_{BB}; |

;/* Update denominator of y-component of P′ in TV and BV*/

ET := ET + Δ_{ET};

/* Update numerator of x-component of P′ in TV and BV */

X̅_{R} := AR/BR; Y̅_{R} := ER/BR; X̅_{L} := AL/BL; Y̅_{L} := ER/BL;

/* Compute x- and y-components of P′ in RV and LV*/
X̅_{T} := ET/BT; Y̅_{T} := AT/BT; X̅_{B} := ET/BB; Y̅_{B} := AB/BB;
/* Compute x- and y-components of P′ in TV and BV*/

| α_{R} := [m X̅_{R} − (m + 1)h]/(2h); | β_{R} := [n Y̅_{R} + (n − 1)h]/(2h); |
|---|---|
| /* (α_{R},β_{R}) is the counterpart of P′ in the STM image's right view */ | |
| α_{L} := [m X̅_{L} + (m + 1)h]/(2h); | β_{L} := [n Y̅_{L} + (n − 1)h]/(2h); |
| /* (α_{L},β_{L}) is the counterpart of P′ in the STM image's left view */ | |
| α_{T} := [m X̅_{T} + (m − 1)h]/(2h); | β_{T} := [n Y̅_{T} − (n + 1)h]/(2h); |
| /* (α_{T},β_{T}) is the counterpart of P′ in the STM image's upper view */ | |
| α_{B} := [m X̅_{B} + (m − 1)h]/(2h); | β_{B} := [n Y̅_{B} + (n + 1)h]/(2h); |

/* (α_{B},β_{B}) is the counterpart of P′ in the STM image's lower view */
ε := Match(x,y,α_{R},β_{R});
if (ε < εᵣ) then {εᵣ := ε; t_{min.r} := t; P_{min.r} := P;}
/* this step keeps track of the digitized element whose projection in the */

/* virtual right view has the smallest difference on intensity value with */
/* A = (x,y) in the central view */

ε := Match(x,y,α_{L},β_{L});

if (ε < εₗ ) then {εₗ := ε; t_{min.l} := t; P_{min.l} := P;}
/* this step keeps track of the digitized element whose projection in the */

/* virtual left view has the smallest difference on intensity value with */
/* A = (x,y) in the central view */

ε := Match(x,y,α_{T},β_{T});

if (ε < εₜ) then {εₜ := ε; t_{min.t} := t; P_{min.t} := P;}
/* this step keeps track of the digitized element whose projection in the */

/* virtual upper view has the smallest difference on intensity value with */
/* A = (x,y) in the central view */

ε := Match(x,y,α_{B},β_{B});

if (ε < ε_{b} ) then { ε_{b} := ε_{b}; t_{min.b} := t; P_{min.b} := P; }
/* this step keeps track of the digitized element whose projection in the */

/* virtual lower view has the smallest difference on intensity value with */
/* A = (x,y) in the central view */
}
Depth_of_A := (Pₘᵢₙ)_{z};

What is claimed is:

1. A system for providing a three-dimensional representation of a scene from a single image, comprising a reflector comprising a plurality of reflective surfaces for providing an interior reflective area defining a substantially quadrilateral cross section;
wherein the reflector reflective surfaces are configured whereby the reflector reflective surfaces provide nine corresponding views of the image.

2. The system of claim 1, wherein the reflector reflective surfaces are fabricated of a material whereby double images are substantially eliminated.

3. The system of claim 1, wherein the reflector reflective surfaces substantially define a square or rectangular side view.

4. The system of claim 1, wherein the reflector reflective surfaces substantially define an isosceles trapezoid in side view.

5. The system of claim 1, further including an imager for converting the nine-view image into digital data.

6. The system of claim 5, wherein the imager is a digital camera or a scanner.

7. The system of claim 6, wherein the imager is a digital camera and the reflector is cooperatively connected to the camera whereby an end of the reflector proximal to the camera is slidably translatable to increase or decrease a distance between said proximal reflector end and a pinhole of the camera.

8. The system of claim 1, further including a client computing device for receiving data from the camera and for rendering said data into a stereoscopic image or an image-plus-depth rendering.

9. The system of claim 8, wherein the step of rendering said data into a stereoscopic image comprises:
obtaining a nine view image from a single scene;
identifying one or more regions in a central view of said nine view image;
identifying corresponding regions in adjacent views to the left and to the right of the central view;
interlacing the central, left, and right images of the identified one or more regions to generate an interlaced image of the identified one or more regions; and
outputting said interlaced image to a display panel for displaying stereoscopic images.

10. The system of claim 8, wherein the step of rendering said data into an image-plus-depth rendering comprises:
calibrating the camera to obtain camera parameters defining a relationship between camera field of view and a view area defined by the reflector;
for one or points on the central view, identifying corresponding points on the remaining eight views in a nine-view image taken from the reflector for the one or more points on the central view, computing a depth from the corresponding one or more points on a left view, a right view, an upper view, and a bottom view of the nine view image;
combining said corresponding points data and said depth data to provide a three-dimensional image.

11. A computer program product available as a download or on a computer-readable medium for installation with a computing device of a user, for rendering a nine view image into a stereoscopic image or an image-plus-depth rendering, comprising:
a first component for identifying a camera location relative to a scene of which a nine view image is to be taken;
a second component for identifying a selected point in a central view of the nine view image and for identifying points corresponding to the selected point in the remaining eight views; and
a third component for identifying a depth of the selected point or points in the central view; and
a fourth component for combining the corresponding points data and the depth data to provide a three-dimensional image.

12. The computer program product of claim 11, wherein the nine view image is obtained by a system comprising:
a camera for translating a single image into digital data; and
a reflector comprising a plurality of reflective surfaces for providing an interior reflective area defining a substantially quadrilateral cross section;
wherein the reflector is cooperatively connected to the camera whereby a longitudinal axis of said reflector is substantially identically aligned with an optical axis of the camera.

13. The computer program product of claim 11, wherein the second and third components may be the same or may identify depth and corresponding points concurrently.

14. A computing system for rendering a nine view image into a stereoscopic image or an image-plus-depth rendering, comprising:
a camera for translating a single image into a digital form;
a reflector comprising a plurality of reflective surfaces for providing an interior reflective area defining a substantially quadrilateral cross section such that the reflective surfaces provide a nine-view image of a scene viewed from a point of view of the camera; and
at least one computing device for receiving data from the camera;
wherein the computing device, for one or points on the central view of the received nine-view image, identifies corresponding points on the remaining eight views in the nine-view image;
further wherein the computing device, for the one or more points on the central view of the received nine-view image, computes a depth from the corresponding one or more points on a left view, a right view, an upper view, and a bottom view of the nine view image;
said corresponding point data and depth data being combined to provide a three-dimensional image.

15. The computing system of claim 14, further including a display for displaying, a three-dimensional image generated by the computing device.
